(19) United States
(12) Patent Application Publication
(10) Pub. No.: US 2023/0144296 A1
(43) Pub. Date: May 11, 2023

(54) FRESNEL LENSES WITH REDUCED OPTICAL ARTIFACTS

(71) Applicant: Meta Platforms Technologies, LLC, Menlo Park, CA (US)

(72) Inventors: Xingzhou TU, Redmond, WA (US); Brian WHEELWRIGHT, Sammamish, WA (US); Alexander SOHN, Seattle, WA (US); Weichuan GAO, Redmond, WA (US); Ying GENG, Bellevue, WA (US); Jacques GOLLIER, Sammamish, WA (US)

(21) Appl. No.: 17/521,446

(22) Filed: Nov. 8, 2021

(51) Int. Cl. G02B 3/08; G02B 27/30

(52) U.S. Cl. CPC G02B 3/08; G02B 27/30; G02B 2003/0093

(57) ABSTRACT

A system includes a light outputting device configured to output a divergent light. The system also includes a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure includes a slope facet and a draft facet. At least one of the draft facets is a first type of draft facet configured to not interact with a ray of the divergent light that is non-parallel with the at least one of the draft facets.

### TECHNICAL FIELD

The present disclosure generally relates to optical lenses and, more specifically, to Fresnel lenses with reduced optical artifacts.

### BACKGROUND

An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within, for example, about 10-20 mm in front of the eyes of a user. The NED system may display virtual objects or combine images of real objects with virtual objects, as in augmented reality (“AR”), virtual reality (“VR”), and/or mixed reality (“MR”) applications. VR, AR, and MR head-mounted displays have wide applications in various fields, including engineering design, medical surgery practice, and video gaming. For example, a user wears a VR head-mounted display integrated with audio headphones while playing video games so that the user can have an interactive experience in an immersive virtual environment.

### SUMMARY OF THE DISCLOSURE

Consistent with an aspect of the present disclosure, a system is provided. The system includes a light outputting device configured to output a divergent light. The system also includes a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure includes a slope facet and a draft facet. At least one of the draft facets is a first type of draft facet configured to not interact with a ray of the divergent light that is non-parallel with the at least one of the draft facets.

Consistent with another aspect of the present disclosure, a system is provided. The system includes a light outputting device configured to output a divergent light. The system also includes a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure includes a slope facet and a draft facet. The draft facets are configured to deflect the divergent light to a region located at the second side of the lens and outside of the light receiving region.

Consistent with another aspect of the present disclosure, a system is provided. The system includes a light outputting device configured to output a divergent light. The system also includes a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure includes a slope facet and a draft facet. The draft facets are configured to deflect the divergent light to at least two of: a first region located at the first side of the lens and outside of the light outputting device, a second region located at the second side of the lens and outside of the light receiving region, and an edge of the lens.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of a system, according to an embodiment of the present disclosure;

FIG. 1B illustrates a schematic cross-sectional view of the system shown in FIG. 1A, according to an embodiment of the present disclosure;

FIG. 2A illustrates a schematic diagram of a conventional Fresnel lens;

FIGS. 2B and 2C illustrate reversely traced rays in a portion of the conventional Fresnel lens shown in FIG. 2A;

FIG. 3A illustrates a schematic diagram of a system including a Fresnel lens with perfect drafts, according to an embodiment of the present disclosure;

FIGS. 3B-3D illustrate enlarged views of reversely traced rays in a portion of the Fresnel lens included in the system shown in FIG. 3A, according to an embodiment of the present disclosure;

FIG. 3E illustrates a diagram of ray tracing for determining draft angles for perfect drafts in the Fresnel lens shown in FIG. 3A, according to an embodiment of the present disclosure;

FIG. 4A illustrates a schematic diagram of a system including a Fresnel lens with null drafts, according to an embodiment of the present disclosure;

FIG. 4B illustrates an enlarged view of reversely traced rays in a portion of the Fresnel lens shown in FIG. 4A, according to an embodiment of the present disclosure;

FIG. 4C illustrates a diagram of ray tracing for determining draft angles for perfect drafts in the Fresnel lens shown in FIG. 4A, according to an embodiment of the present disclosure;

FIG. 5A illustrates a schematic diagram of a Fresnel lens with hybrid drafts, according to an embodiment of the present disclosure;

FIG. 5B illustrates a schematic diagram of a Fresnel lens with hybrid drafts, according to an embodiment of the present disclosure;

FIG. 6A illustrates a schematic diagram of a system including a Fresnel lens with null-plus (“null+”) drafts, according to an embodiment of the present disclosure;

FIGS. 6B-6D illustrate enlarged views of reversely traced rays in portions of the Fresnel lens shown in FIG. 6A, according to an embodiment of the present disclosure;

FIG. 6E illustrates a diagram of a first stage ray tracing for determining draft angles for perfect drafts in the Fresnel lens shown in FIG. 6A, according to an embodiment of the present disclosure;

FIG. 6F illustrates a diagram of a second stage ray tracing for determining draft angles for perfect drafts in the Fresnel lens shown in FIG. 6A, according to an embodiment of the present disclosure;

FIG. 7A illustrates a schematic diagram of a Fresnel lens with zigzag drafts, according to an embodiment of the present disclosure;

FIG. 7B illustrates a schematic diagram of an enlarged view of a portion of the Fresnel lens shown in FIG. 7A, according to an embodiment of the present disclosure;

FIG. 8A illustrates a schematic diagram of a system, according to an embodiment of the present disclosure;

FIG. 8B illustrates a schematic diagram of a Fresnel lens included in the system shown in FIG. 8A, according to an embodiment of the present disclosure; and

FIG. 8C illustrates a schematic diagram of a Fresnel structure included in the Fresnel lens shown in FIG. 8B, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The wavelength bands, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a majority portion, including all, of a light is transmitted, reflected, diffracted, or blocked, etc. The majority portion may be a predetermined percentage (greater than 50%) of the entire light, such as 100%, 98%, 90%, 85%, 80%, etc., which may be determined based on specific application needs.

Conventional head-mounted displays are larger and heavier than typical eyeglasses, because conventional head-mounted displays often include a complex set of optics that are bulky and heavy. It is not easy for users to get used to wearing such large and heavy head-mounted displays. The bulky size and heavy weight of conventional head-mounted displays limit their applications. Fresnel lenses have been used to replace the continuous curved surface of a conventional optical lens with a series of concentric annular sections that are offset from one another (e.g., for a circular Fresnel lens). These contours function as individual refracting surfaces to bend parallel rays to a common focal point. Fresnel lenses may provide apertures and focal lengths comparable to conventional lenses, with a smaller thickness and weight. Thus, Fresnel lenses may be cost-effective, lightweight alternative to conventional continuous surface optics. Head-mounted displays including Fresnel lenses may have reduced sizes and weights as compared to those including conventional lenses. However, Fresnel lenses may suffer from diffractions and other stray light artifacts associated with Fresnel structures, which may limit their applications.

The present disclosure provides various Fresnel lenses with compact sizes, light weights, reduced optical artifacts, reduced visibility of Fresnel structures, and improved image quality. The disclosed Fresnel lenses may be implemented in various devices or systems, e.g., head-up displays (“HUDs”), head-mounted displays (“HMDs”), near-eye displays (“NEDs”), smart phones, laptops, televisions, vehicles, etc., to enhance the user experience of virtual-reality (“VR”), augmented reality (“AR”), and/or mixed reality (“MR”).

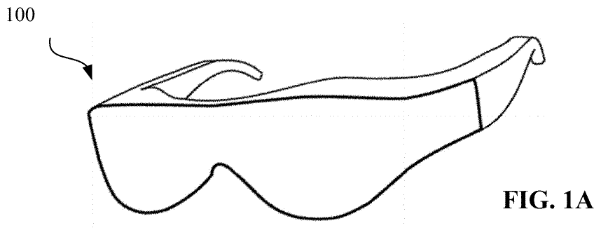

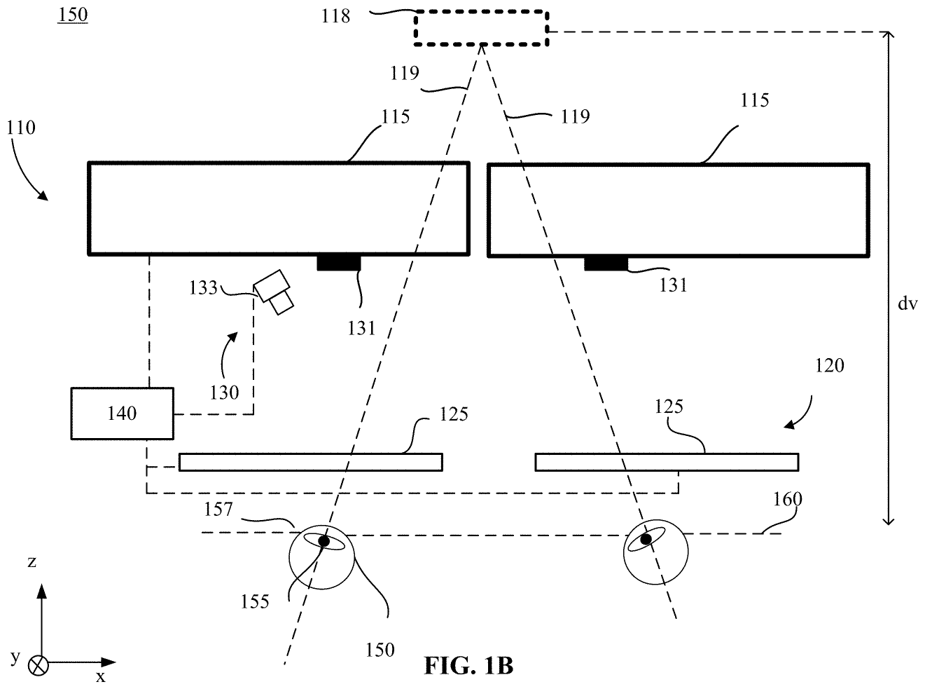

FIG. 1A illustrates a schematic diagram of a system 100, according to an embodiment of the present disclosure. The system 100 may be an optical system configured for AR, MR, and/or VR applications. In some embodiments, the system 100 may be configured to be worn on a head of a user (e.g., by having the form of spectacles or eyeglasses, as shown in FIG. 1A) or to be included as part of a helmet that is worn by the user. In some embodiments, the system 100 may be referred to as a head-mounted display. In some embodiments, the system 100 may be configured for placement in proximity of an eye or eyes of the user at a fixed location in front of the eye(s), without being mounted to the head of the user. For example, the system 100 may be mounted in a vehicle, such as a car or an airplane, at a location in front of an eye or eyes of the user.

FIG. 1B schematically illustrates an x-y sectional view of the system 100 shown in FIG. 1A, according to an embodiment of the present disclosure. The system 100 may include a display module 110, a viewing optical module 120, an object tracking system 130, and a controller 140. The object tracking system 130 may be an eye tracking system and/or face tracking system. The display module 110 may display virtual images to a user. In some embodiments, the display module 110 may include a single electronic display or multiple electronic displays 115. For discussion purposes, FIG. 1B shows two electronic displays 115 for left and right eyes 150 of the user, respectively. The electronic display 115 may include a display panel (also referred to as 115 for discussion purposes), such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the display panel 115 may be a self-emissive panel, such as an OLED display panel or a micro-LED display panel. In some embodiments, the display panel 115 may be a display panel that is illuminated by an external source, such as an LCD panel, an LCoS display panel, or a DLP display panel. Examples of an external source may include a laser, an LED, an OLED, or a combination thereof.

The viewing optical module 120 may be arranged between the display module 110 and the eyes 150, and may be configured to guide an image light for forming a virtual image output from the display module 110 to an exit pupil 157 in an eye-box region 160. The exit pupil 157 may be a location where an eye pupil 155 of the eye 150 is positioned in the eye-box region 160 of the system 100. For example, the viewing optical module 120 may include one or more optical elements configured to correct aberrations in an image light output from the display module 110, magnify an image light output from the display module 110, or perform another type of optical adjustment of an image light output from the display module 110. Examples of the one or more optical elements may include an aperture, a Fresnel lens, a convex lens, a concave lens, a filter, or any other suitable optical element that affects an image light. For discussion purpose, FIG. 1B shows that the viewing optical module 120 may include two lens assemblies 125 for the left and right eyes 150, respectively. In some embodiments, the lens assembly 125 may include a Fresnel lens or a Fresnel lens array.

The object tracking system 130 may include an IR light source 131 configured to emit an IR light to illuminate the eyes 150 and/or the face. The object tracking system 130 may also include an optical sensor 133, such as a camera, configured to receive the IR light reflected by each eye 150 and generate a tracking signal relating to the eye 150, such as an image of the eye 150. In some embodiments, the object tracking system 130 may also include an IR deflecting element (not shown) configured to deflect the IR light reflected by the eye 150 toward the optical sensor 133.

The controller 140 may be communicatively coupled with the display module 110, the viewing optical module 120, and/or the object tracking system 130 to control the operations thereof. The controller 140 may include a processor or processing unit. The processor may by any suitable processor, such as a central processing unit (“CPU”), a graphic processing unit (“GPU”), etc. The controller 140 may include a storage device. The storage device may be a non-transitory computer-readable medium, such as a memory, a hard disk, etc. The storage device may be configured to store data or information, including computer-executable program instructions or codes, which may be executed by the processor to perform various controls or functions described in the methods or processes disclosed herein.

In some embodiments, the lens assembly 125 may be configured with an adjustable optical power to address an accommodation-vergence conflict in the system 100. For example, the lens assembly 125 may be configured with a large aperture size, such as 50 mm, for a large field of view, such as 65 degrees with 20 mm eye relief distance, a large optical power for adapting human eye vergence accommodation, such as ±2.0 Diopters, a fast switching speed at the milli-seconds level or tens of milliseconds level for adapting vergence-accommodation of human eyes, and a high image quality for meeting human eye acuity.

For example, each electronic display 115 may display a virtual image or a portion of the virtual image. Based on the eye tracking information provided by the eye tracking module 130, the controller 140 may determine a virtual object 118 within the virtual image at which the eyes 150 are currently looking. The controller 140 may determine a vergence depth (dᵥ) of the gaze of the user based on the gaze point or an estimated intersection of gaze lines 119 determined by the object tracking system 130. As shown in FIG. 1B, the gaze lines 119 may converge or intersect at the distance dᵥ, where the virtual object 118 is located. The controller 140 may control the lens assemblies 125 to adjust the optical power to provide an accommodation that matches the vergence depth (dᵥ) associated with the virtual object 118 at which the eyes 150 are currently looking, thereby reducing the accommodation-vergence conflict in the system 100. For example, the controller 140 may control the lens assembly 125 to operate in a desirable operation state to provide an optical power corresponding to a focal plane or an image plane that matches with the vergence depth (dᵥ).

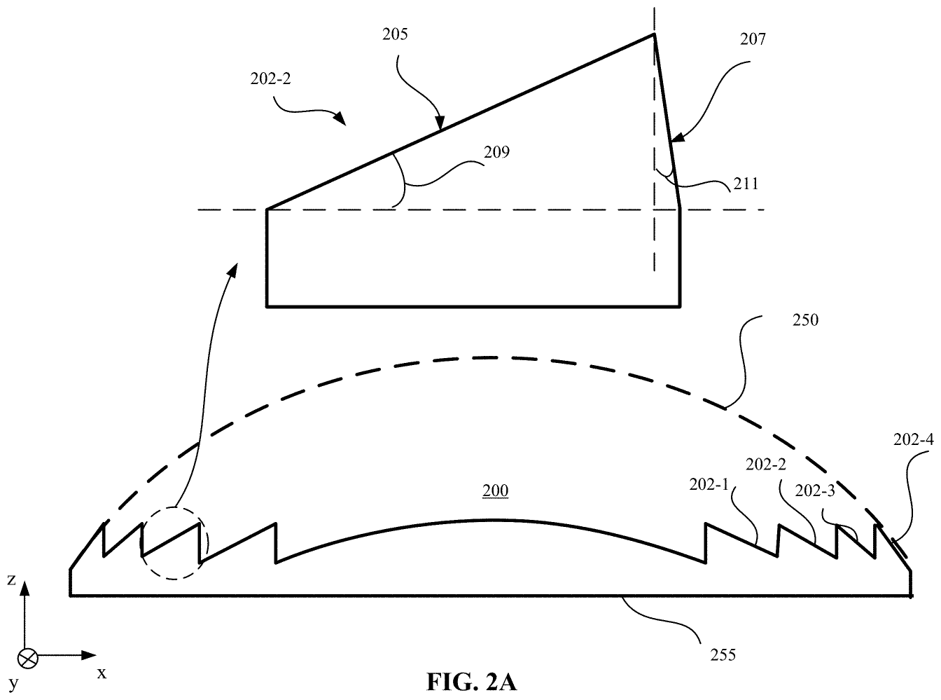

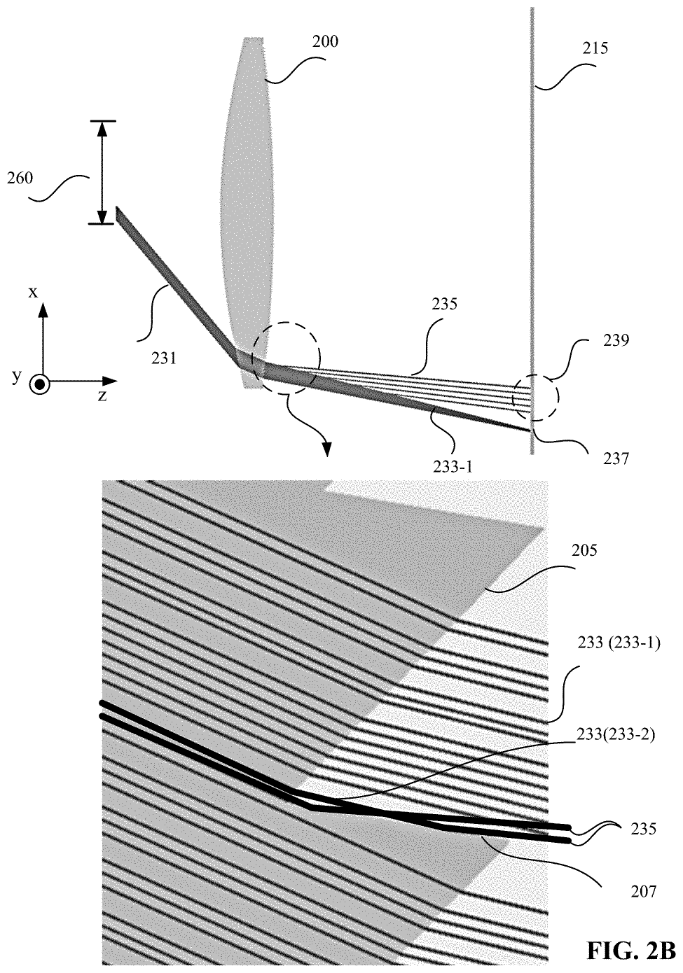

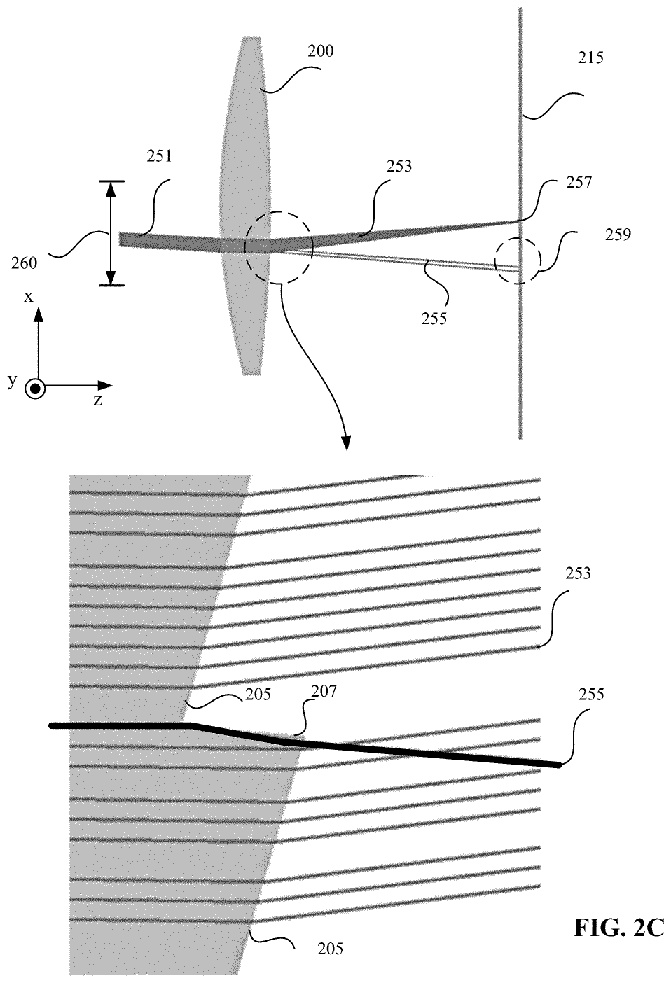

FIG. 2A illustrates an x-z section of a conventional Fresnel lens 200. As shown in FIG. 2A, the conventional Fresnel lens 200 may be considered as “collapsing” or “compressing” a continuous convex surface of a conventional optical lens 250 onto a plane 255. In this way the lens thickness may be reduced. The conventional Fresnel lens 200 shown in FIG. 2A may be a spherical Fresnel lens including a plurality of Fresnel structures 202-1, 202-2, 202-3, and 202-4. The Fresnel structures may be radial-symmetric concentric-cone segments 4. Each Fresnel structure 202-1, 202-2, 202-3, or 202-4 may include a slope facet 205, and a draft facet 207 adjacent to the slope facet 205, as shown in the enlarged view of the exemplary Fresnel structure 202-3. The neighboring slope facets 205 may be separated by the draft facets 207. In this description, a draft facet is also referred to as a draft.

The slope facets 205 may be actual surfaces used to approximate the curvature of the conventional optical lens 250 and refract the rays in a prescribed or designed manner. The slope facet 205 may be characterized by a slope angle 209 with respect to a reference axis, such as an x-axis shown in FIG. 2A, or a plane 255 of the Fresnel lens 200. For example, from a central region to a periphery region of the Fresnel lens 200, the slope angles 209 of the Fresnel structures 202-1, 202-2, 202-3, and 202-4 may gradually increase.

The draft facet 207 may connect adjacent slope facets, and may represent discontinuities between the slope facets 205 to return the surface profile “back to the plane”. The draft facet 207 may be characterized by a draft angle 211 with respect to a reference axis, such as a z-axis shown in FIG. 2A, or an optical axis of the Fresnel lens 200, or with respect to a normal of the plane 255 of the Fresnel lens 200. In the conventional Fresnel lens 200, the draft angles 211 of the Fresnel structures 262-1, 262-2, 262-3, and 262-4 may be substantially the same. The draft angles 211 may be a few degrees with respect to the normal of the plane 255 of the Fresnel lens 200. The small draft angles 211 may facilitate mold release in the fabrication process. The conventional Fresnel lens 200 may suffer from optical artifacts caused by stray lights output from the draft facets 207. The optical artifacts may be observed at an image plane, e.g., in the form of arcs, rainbows, or ghost images. The draft angles 211 of the respective Fresnel structures 262-1, 262-2, 262-3, and 262-4 may not be specifically or intentionally configured for reducing such optical artifacts.

For example, in a VR display device, as shown in FIG. 2B, the Fresnel lens 200 may be disposed between the eyes 150 and an electronic display 215. The Fresnel lens 200 may transform the image light emitted from each point on the display panel 215 to a bundle of parallel rays or a collimated light that substantially covers an eye-box 260. FIGS. 2B and 2C illustrate reversely traced rays from the eye-box 260 to the display panel 215 with the Fresnel lens 200 disposed therebetween. FIGS. 2B and 2C show that the interaction between incoming lights and the draft facet 207 of the Fresnel structure 202-1, 202-2, 202-3, or 202-4 may increases stray lights, thereby increasing the optical artifacts and degrading the image quality.

As shown in FIG. 2B, the eye-box 260 is presumed to output a bundle of parallel rays or a collimated light 231 propagating toward a periphery portion of the Fresnel lens 200. Referring to the enlarged view of the periphery portion of the Fresnel lens 200 in FIG. 2B, the light 231 may be refracted by the slope facet 205 of the Fresnel structure 202-1, 202-2, 202-3, or 202-4 as a light 233 prorogating in the air. A first portion 233-1 of the light 233 may be substantially focused to a first region 237 on the display panel 215. A second portion 233-2 of the light 233 may be incident onto the outer surface of the draft facet 207, and reflected by the outer surface of the draft facet 207 as a light 235, which is referred to as a stray light. Such a reflection by the outer surface of the draft facet 207 is referred to an “outer mode” herein. The light 235 may propagate toward a second region 239 of the display panel 215 different from the first region 237. The separation between the light 233 focused to the first region 237 of the display panel 215 and the stray light 235 propagating to the second region 239 of the display panel 215 may result in optical artifacts.

As the optical paths are reversible, when the first region 237 on the display panel 215 outputs a bundle of divergent rays or a divergent image light toward the periphery portion of the Fresnel lens 200, the Fresnel lens 200 may transform a first portion of the divergent image light to a collimated light propagating toward a first region of the eye-box 260, and transform a second portion of the divergent image light to an uncollimated light propagating toward a second region of the eye-box 260 different from the first region of the eye-box 260, resulting in optical artifacts that may be perceived by the eyes placed within the eye-box 260.

As shown in FIG. 2C, the eye-box 260 is presumed to output a bundle of parallel rays or a collimated light 251 toward a central portion of the Fresnel lens 200. Referring to the enlarged view of the central portion of the Fresnel lens 200 in FIG. 2C, a first portion of the light 251 may be incident onto the slope facet 205, and refracted by the slope facet 205 as a light 253. The light 253 may be substantially focused to a first region 257 of the display panel 215. A second portion of the light 251 may be incident onto the inner surface of the draft facet 207, reflected by the inner surface of the draft facet 207, e.g., via total internal reflection, toward the slope facet 205, then refracted by the slope facet 205 as a light 255, which is referred to as a stray light. Such a reflection by the inner surface of the draft facet 207 is referred to an “inner mode” herein. The light 255 may propagate toward a second region 259 of the display panel 215 different from the first region 257. The separation between the light 253 focused to the first region 257 of the display panel 215 and the stray light 255 propagating to the second region 259 of the display panel 215 may result in optical artifacts.

As the optical paths are reversible, when the first region 257 of the display panel 215 outputs a bundle of divergent rays or a divergent image light toward the central portion of the Fresnel lens 200, the Fresnel lens 200 may transform a first portion of the divergent image light to a collimated light propagating toward a first region of the eye-box 260, and transform a second portion of the divergent image light to an uncollimated light propagating toward a second region of the eye-box 260. The second region of the eye-box 260 may be different from the first region of the eye-box 260. The separation between the two lights at the two regions may result in optical artifacts that may be perceived by the eyes placed within the eye-box 260.

In the following, various Fresnel lenses with specifically configured draft facets (e.g., draft angles, surface profiles of the draft facets, etc.) according to embodiments of the present disclosure will be explained. The disclosed Fresnel lenses may have reduced optical artifacts, a reduced visibility of the Fresnel structures, and an improved image quality. The disclosed Fresnel lenses may be implemented into various system and devices for, e.g., for AR, VR, and/or MR applications. For example, the disclosed Fresnel lenses may be implemented in the lens assemblies 125 included in the viewing optical module 120 of the system 100 shown in FIG. 1B. In the following descriptions, spherical Fresnel lenses are used as examples to explain the design principles for reducing the optical artifacts and the visibility of the Fresnel structures, and increasing the image quality. The disclosed design principles of the Fresnel lenses may also be applied to other Fresnel lenses, such as cylindrical Fresnel lenses.

A Fresnel lens of the present disclosure may include a first lens surface and a second lens surface opposite to the first lens surface. At least one of the first lens surface or the second lens surface may include a plurality of Fresnel structures, e.g., a plurality of radial-symmetric concentric-cone segments. Each Fresnel structure may have a slope facet and a draft facet disposed adjacent to the slope facet. Two neighboring slope facets may be separated or connected by the draft facets. The slope facet may be configured with a slope angle. In some embodiments, from a central region to a periphery region of the Fresnel lens, the slope angles of the Fresnel structures may gradually increase. The draft facet may be configured with a draft angle. Configurations of the draft facets, such as the draft angle, the surface profile of the draft facets, etc., may be specifically designed to reduce the optical artifacts caused by stray lights, reduce the visibility of the Fresnel structures, and increase the image quality of the Fresnel lens.

In some embodiments, the Fresnel lens of the present disclosure may be disposed between the electronic display 115 and the eye-box 160, with the first lens surface facing the electronic display 115 and the second lens surface facing the eye-box 160. An image light output from the electronic display 115 may be first incident onto the first lens surface of the Fresnel lens. The aperture size of the Fresnel lens, the size of the eye-box 160, the size of the display panel of the electronic display 115, the distance between the Fresnel lens and the eye-box 160, and the distance between the Fresnel lens and the electronic display 115 may be determined according to various requirements of a display system that includes the Fresnel lens and the electronic display 115. In the following, the draft facets of the Fresnel structures located the first lens surface are used as examples to explain the design principles for reducing the optical artifacts, reducing the visibility of the Fresnel structures, and increasing the image quality. The disclosed design principles of the draft facets may also be applied to the draft facets of the Fresnel structures located at the second lens surface if the second lens surface includes any Fresnel structures.

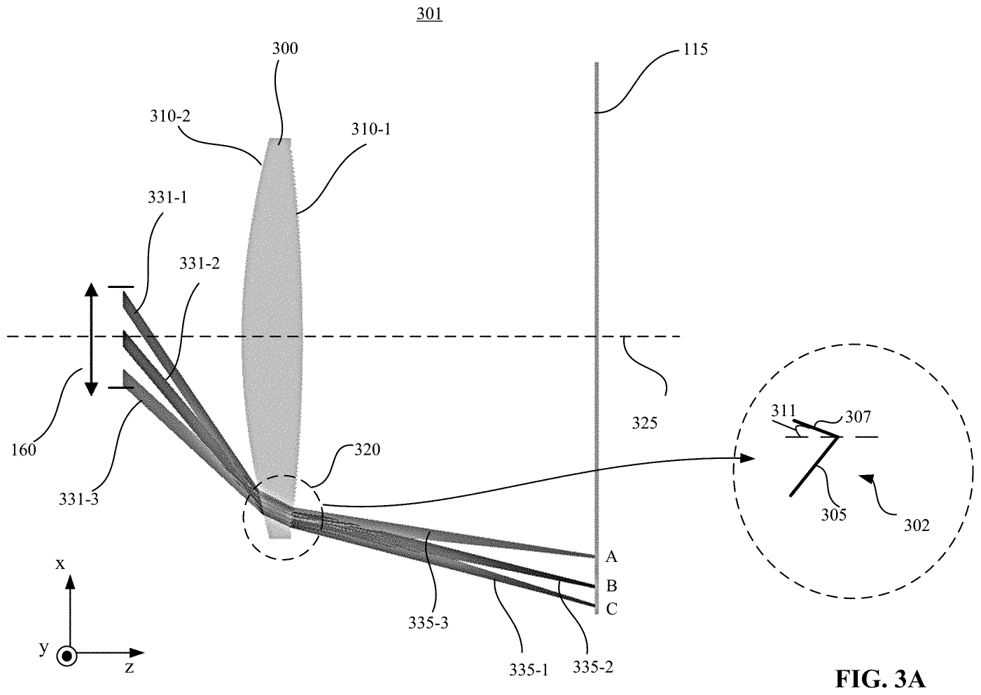

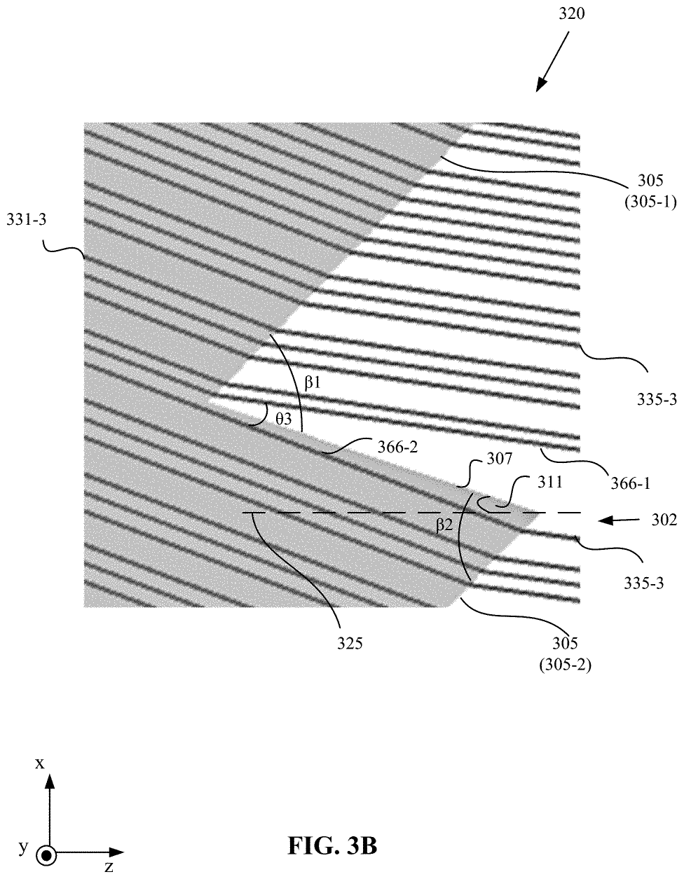

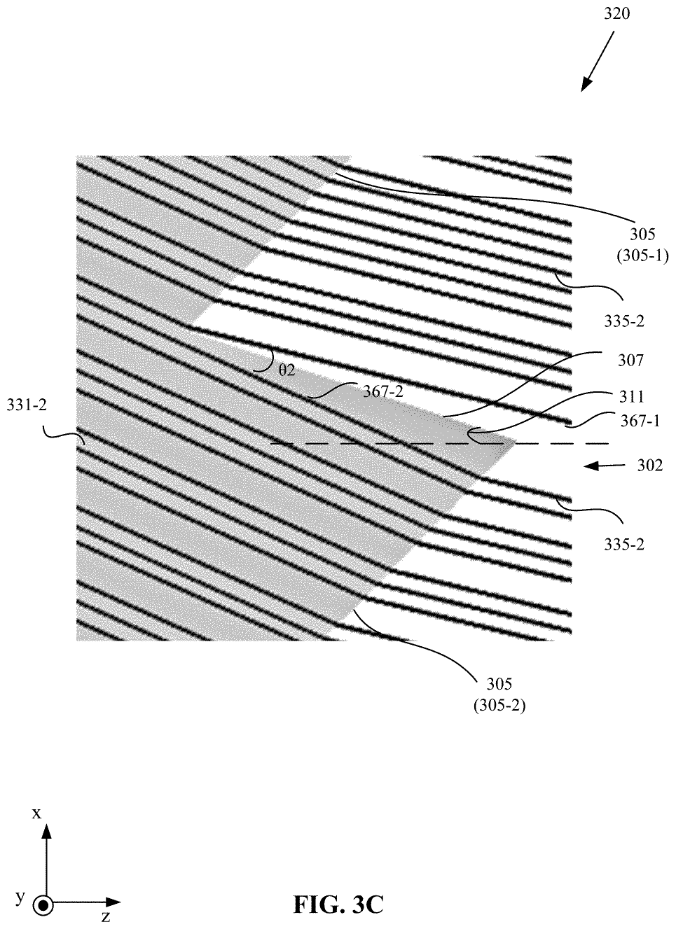

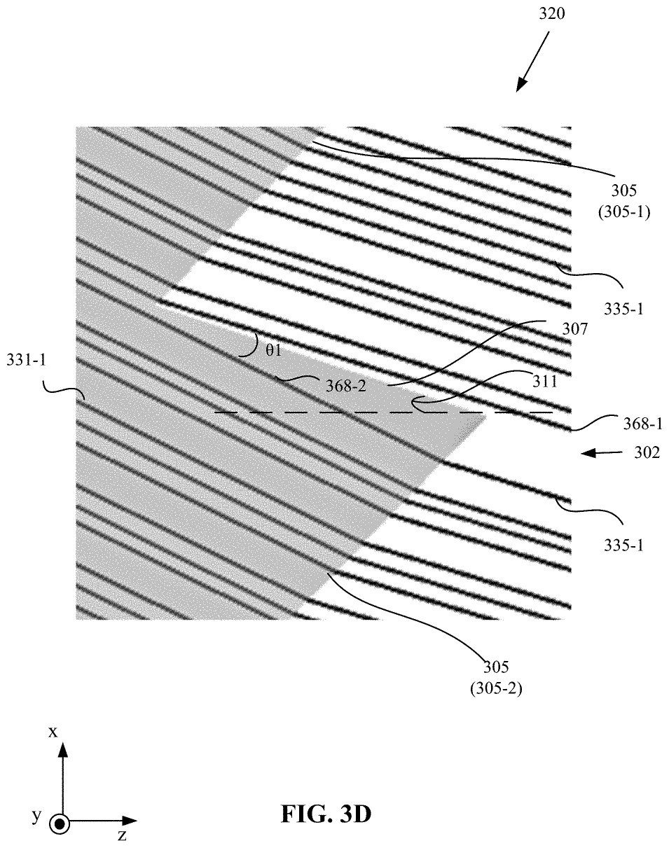

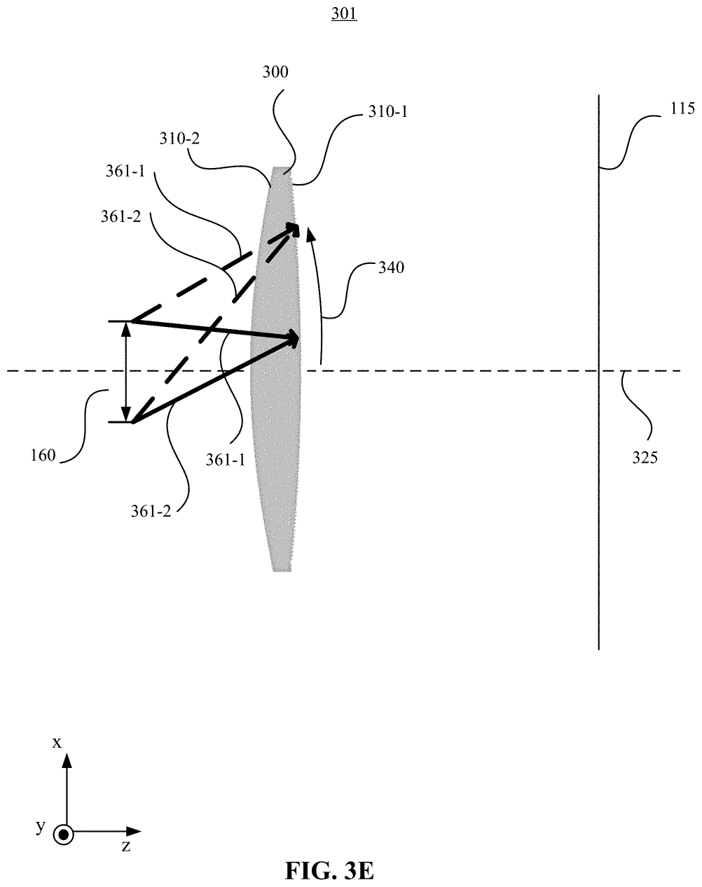

FIG. 3A illustrates an x-z sectional view of a system 301, according to an embodiment of the present disclosure. The system 301 may include the electronic display 115 and a Fresnel lens 300 configured with “perfect drafts.” In some embodiments, the Fresnel lens 300 may include all perfect drafts. The term “perfect draft” is used to refer to a first type of draft facets (also referred to as draft) that does not generate a stray light. A perfect draft may not interact with an image light (output from the electronic display 115) incident onto the Fresnel lens 300. The image light incident onto the Fresnel lens 300 are not deflected (e.g., reflected) by the outer or inner surface of the perfect draft. The electronic display 115 may include a display panel (also referred to as 115 for discussion purposes). The Fresnel lens 300 may include an optically transparent substrate having a first lens surface 310-1 facing the display panel 115 and a second lens surface 310-2 facing the eye-box 160. The Fresnel lens 300 may be configured to transform an image light, such as a divergent image light, emitted from each point on the display panel 115 to a bundle of parallel rays or a collimated light that substantially covers the eye-box 160. When the eyes of the user are placed within the eye-box 160, the user may observe an image displayed on the display panel 115.

The Fresnel lens 300 may include a plurality of Fresnel structures located at or on at least one of the first lens surface 310-1 or the second lens surface 310-2. FIG. 3A shows that the Fresnel structures are formed on the first lens surface 310-1. FIG. 3A also illustrates an enlarged view of a Fresnel structure 302 of the Fresnel lens 300, according to an embodiment of the present disclosure. As shown in FIG. 3A, the Fresnel structure 302 may include a slope facet 305 characterized by a slope angle and a draft facet or draft 307 characterized by a draft angle 311. The draft angle 311 may be an angle formed between the draft facet 307 and a direction parallel with an optical axis 325 of the Fresnel lens 300. The draft angles 311 of the respective draft facets 307 may be specifically configured, such that when each point on the display panel 115 outputs an image light, such as a divergent image light, to the Fresnel lens 300, the image light may be incident onto only the slope facets 305, and then be refracted by the slope facets 305 toward the eye-box 160, without interacting with the draft facets 307. Hence, the draft facet 307 is also referred to as a perfect draft.

The image light output from the display panel 115 may not be incident onto the outer surface of the draft facets 307, and may not be reflected at the outer surface of the draft facets 307. Thus, the “outer mode” reflection of the image light may be reduced. The image light refracted by the slope facets 305 may include rays that are parallel with the draft facets 307, and rays that are unparallel with the draft facets 307. The draft angles 311 of the draft facets 307 may be configured such that even the rays unparallel with the draft facets 307 do not interact with the draft facets 307, i.e., are not reflected by either the inner surface or the outer surface of the draft facets 307. The image light refracted by the slope facets 305 may not be incident onto the inner surface of the draft facets 307, and may not be reflected at the inner surface of the draft facets 307. Thus, the “inner mode” reflection of the image light may be reduced. Accordingly, the image light output from the display panel 115 may not be reflected at the inner surface and outer surface of the draft facets 307 as stray lights. As a result, the stray lights may be significantly reduced. Therefore, the optical artifacts caused by the stray lights may be significantly reduced. The eye located within the eye-box 160 may not perceive the stray lights, and may not perceive the optical artifacts caused by the stray lights.

In some embodiments, the Fresnel lens 300 with perfect drafts 307, the draft angles 311 of all of the draft facets 307 may be substantially the same. In some embodiments, the draft angles 311 of at least two draft facets 307 may be different. In some embodiments, the draft angles 311 of all of the draft facets 307 may be different from one another, e.g., may be based on a distance of the respective Fresnel structure 302 from the optical axis 325.

FIG. 3A illustrates reversely traced rays from the eye box 160 to the display panel 115, with the Fresnel lens 300 disposed therebetween. As shown in FIG. 3A, the eye-box 160 is presumed to output three bundles of parallel rays or three collimated lights 331-1, 331-2, and 331-3 toward a same predetermined region 320 at the first lens surface 310-1 of the Fresnel lens 300. The predetermined region 320 may include at least one Fresnel structure 302 located at, e.g., a periphery portion of the Fresnel lens 300. The three collimated lights 331-1, 331-2, and 331-3 may be output from an upper edge, a center, and a lower edge of the eye-box 160, respectively.

FIGS. 3B-3D illustrate enlarged views of the reversely traced rays at a portion of a predetermined region 320 of the Fresnel lens 300 for the three collimated lights 331-3, 331-2, and 331-1, respectively. As shown in FIG. 3B, the perfect draft 307 may connect two neighboring slope facets 305-1 and 305-2. The slope facet 305-2 may be included in the Fresnel structure 302 with the perfect draft 307, and the slope facet 305-1 may belong to a preceding Fresnel structure. The perfect draft 307 may form an acute angle β1 and an acute angle β2 with the two neighboring slope facets 305-1 and 305-2. As shown in FIG. 3B, the perfect draft 307 may be located within a zone formed by two closest rays (366-1 and 366-2) of the collimated light 331-3 incident onto the Fresnel lens 300. The ray 366-1 may be a ray that has been refracted by the slope facet 305-1 and is closest to the perfect draft 307. The ray 366-1 may be propagating in an external environment (e.g., air) of the Fresnel lens 300. The ray 366-2 may be a ray that is propagating within the body of the Fresnel lens 300 to be refracted by the slope facet 305-2 and is closest to the perfect draft 307. The zone formed by the two closest rays 366-1 and 366-2 may be a triangular zone represented by an angle θ3 and starting around a crossing point between the slope facet 305-1 and the draft facet 307. In some embodiments, the angle θ3 may be in a range of 5°-10°, 10°-20°, 20°-30°, 30°-40°, etc.

As shown in FIG. 3B, the draft angle 311 may be configured with respect to the optical axis 325 and the paired slope facet 305-2, such that the rays (of the collimated light 331-3) that are non-parallel with the draft facets 307 do not interact with the draft facets 307. That is, the rays that are non-parallel with the draft facets 307, such as the ray 366-1 and 366-2, are not reflected by either the inner surface or the outer surface of the draft facets 307, which are perfect drafts.

As the optical paths are reversible, when the draft facet 307 is configured to be located within the triangular zone formed by the two adjacent rays 366-1 and 366-2 (of the collimated light 331-3) described above, the draft facet 307 may be a perfect draft that does not interact with the image light output from the display panel 115. Thus, the perfect drafts 307 may not generate stray lights when the image light output from the display panel 115 incident thereon.

As shown in FIG. 3C, the perfect draft 307 may be located within a zone formed by two closest rays (367-1 and 367-2) of the collimated light 331-2 incident onto the Fresnel lens 300. The ray 367-1 may be a ray that has been refracted by the slope facet 305-1 and is closest to the perfect draft 307. The ray 367-1 may be propagating in an external environment (e.g., air) of the Fresnel lens 300. The ray 367-2 may be a ray that is propagating within the body of the Fresnel lens 300 to be refracted by the slope facet 305-2 and is closest to the perfect draft 307. The zone formed by the two closest rays 367-1 and 367-2 may be a triangular zone represented by an angle θ2 and starting around a crossing point between the slope facet 305-1 and the draft facet 307. In some embodiments, the angle θ2 may be in a range of 5°-10°, 10°-20°, 20°-30°, 30°-40°, etc.

As shown in FIG. 3D, the perfect draft 307 may be located within a zone formed by two closest rays (368-1 and 368-2) of the collimated light 331-1 incident onto the Fresnel lens 300. The ray 368-1 may be a ray that has been refracted by the slope facet 305-1 and is closest to the perfect draft 307. The ray 368-1 may be propagating in an external environment (e.g., air) of the Fresnel lens 300. The ray 368-2 may be a ray that is propagating within the body of the Fresnel lens 300 to be refracted by the slope facet 305-2 and is closest to the perfect draft 307. The zone formed by the two closest rays 368-1 and 368-2 may be a triangular zone represented by an angle θ1 and starting around a crossing point between the slope facet 305-1 and the draft facet 307. In some embodiments, the angle θ1 may be in a range of 5°-10°, 10°-20°, 20°-30°, 30°-40°, etc.

For the three collimated lights 331-3, 331-2, and 331-1 that may be respectively output from the upper edge, the center, and the lower edge of the eye-box 160, FIGS. 3B, 3C, and 3D show the that draft facet 307 (perfect draft) may form different angles with respect to the rays 366-2, 367-2, 368-2 propagating within the body of the Fresnel lens 300 that are closest to the draft facet 307. The draft facets 307 (perfect drafts) may be configured to be located within the respective triangular zones represented by the angle θ3, the angle θ2, and the angle θ1, respectively.

In some embodiments, the configuration of the draft angle 311 may be based on the parameters of the system 301, such as the size of the Fresnel lens 300, the optical power of the Fresnel lens 300, the size of the eye-box 160, the size of the display panel of the electronic display 115, the distance between the Fresnel lens 300 and the eye-box 160, the distance between the Fresnel lens 300 and the electronic display 115, the material of the Fresnel lens 300, and the outside environment of the Fresnel lens 300, etc. The draft angle 311 may be configured within a predetermined angular range, such that the rays 331-1, 331-2, and 331-3 output from the eye-box 160 may interact with the slope facet 305 only, and may not interact with the draft facet 307. The draft angle 311 of the perfect draft 307 may be designed, such that the angle between the perfect draft 307 and the ray 366-2 propagating within the body of the Fresnel lens 300 is between 0 and the angle θ. In some embodiments, the angle may be 0 or 0. In some embodiments, the angle may be greater than 0 and smaller than the angle θ. Note that in designing the perfect draft, the rays that are parallel with the perfect draft are not considered since these rays do not interact with the perfect draft. The design principle focuses on the situation where rays are not parallel with the draft facet 307.

As shown in FIG. 3A, the rays 331-1, 331-2, and 331-3 may be incident onto the slope facets 305, and refracted as rays 335-1, 335-2, and 335-3, respectively. The rays 335-1, 335-2, and 335-3 refracted by the slope facets 305 may include rays that are parallel to the draft facet 307 and rays that are unparallel to the draft facet 307. The rays 335-1, 335-2, and 335-3 may be focused to points A, B, and C on the display panel 115, respectively. As shown in FIGS. 3B-3D, the collimated lights 331-1, 331-2, and 331-3 output from the eye-box 160 may not be incident onto the inner surface of the draft facets 307. The collimated lights 335-1, 335-2, and 335-3 refracted by the slope facets 305 may not be incident onto the inner surface of the draft facets 307. Thus, the draft facets 307 may not transform the rays 331-1, 331-2, and 331-3 output from the eye-box 160 to stray lights. Thus, no optical artifacts formed by stray lights may be perceived by the eyes of the user.

The predetermined angular range of the draft angle 311 for a perfect draft may be determined through ray tracing. FIG. 3E illustrates a diagram of ray tracing for determining the draft angle 311 for the perfect draft, according to an embodiment of the present disclosure. In the ray tracing, the parameters of the system 301, such as the size of the Fresnel lens 300, the size of the eye-box 160, the size of the display panel of the electronic display 115, the distance between the Fresnel lens 300 and the eye-box 160, the distance between the Fresnel lens 300 and the electronic display 115, the material of the Fresnel lens 300, and the outside environment of the Fresnel lens 300, are presumed to be fixed. In the ray tracing, the pitches of the respective draft facets 307 are presumed to be infinitely small. The draft angles 311 of the respective draft facets 307 may be substantially the same.

The first lens surface 310-1 may be axial symmetric with respect to the optical axis 325 of the Fresnel lens 300. For example, the first lens surface 310-1 may be divided into a first half, e.g., an upper half shown in FIG. 3E, and a second half, e.g., a lower half shown in FIG. 3E. The first half and the second half are symmetric with respect to the optical axis 325 of the Fresnel lens 300. As the first lens surface 310-1 is axial symmetric with respect to the optical axis 325 of the Fresnel lens 300, ray tracing from the eye-box 160 to the display panel 115 may be performed for only half of the first lens surface 310-1 to determine the draft angle 311 for a perfect draft. For example, the upper half of the first lens surface 310-1 may be divided into a plurality of regions. Each region may include at least one Fresnel structure 302. The upper half of the first lens surface 310-1 may be “scanned” by a first ray 361-1 and a second ray 361-2 output from the eye-box 160, in a direction from a center portion of the first lens surface 310-1 to a peripheral portion of the first lens surface 310-1. For illustrative purposes, the direction is represented by an arrow 340.

The first ray 361-1 may be output from the upper edge of the eye-box 160 toward the respective region. The second ray 361-2 may be output from the lower edge of the eye-box 160 toward the respective region. The first ray 361-1 and the second ray 361-2 may enter the Fresnel lens 300 from the second lens surface 310-2 facing the eye-box 160. The first ray 361-1 and the second ray 361-2 may propagate from the second lens surface 310-2 to the respective region of the upper half, and exit the Fresnel lens 300 from the first lens surface 310-1 facing the display panel 115. For illustrative purposes, FIG. 3E shows that as the first ray 361-1 and the second ray 361-3 scan the upper half of the first lens surface 310-1 in the direction 340 from the center portion of the first lens surface 310-1 to the peripheral portion of the first lens surface 310-1, the first ray 361-1 and the second ray 361-3 are incident onto a first region of the upper half at a first time moment, and incident onto a second region of the upper half different from the first region at a second time moment.

As scanning the upper half of the first lens surface 310-1 in the direction 340, each of the first ray 361-1 and the second ray 361-3 may be incident onto the respective region of the upper half of the first lens surface 310-1 with an incidence angle in the Fresnel lens 300, and refracted by the respective region of the upper half with a refraction angle in the outside environment, such as air. In the ray tracing, the incidence angle of a ray in the Fresnel lens 300 may be defined as an angle between the ray and the optical axis 325. The refraction angle of a ray in the outside environment, e.g., air, may be defined as an angle between the ray and the optical axis 325.

In the present disclosure, an angle of a ray or light with respect to an optical axis of a Fresnel lens may be defined as a positive angle or a negative angle, depending on the angular relationship between a propagating direction of the ray and the optical axis of the Fresnel lens. For example, when the propagating direction of the ray is clockwise from the optical axis of the Fresnel lens, the angle of the ray may be defined as a negative angle, and when the propagating direction of the ray is counter-clockwise from the optical axis of the Fresnel lens, the angle of the ray may be defined as a positive angle.

As scanning the upper half of the first lens surface 310-1 in the direction 340, for each region of the upper half of the first lens surface 310-1 that has been scanned or ray traced, a refraction angle θ₁ of the first ray 361-1 in the outside environment and an incidence angle θ₂ of the second ray 361-2 in the Fresnel lens 300 may be obtained and compared. When the absolute value of the refraction angle θ₁ of the first ray 361-1 in the air is found to be less than the absolute value of the incidence angle θ₂ of the second ray 361-2 in the Fresnel lens 300 for the first time, i.e., |θ₁|<|θ₂|, the optical power of that region of the first lens surface 310-1 may be considered to be sufficient to angularly separate the ray bundle in the outside environment and the ray bundle in the Fresnel lens 300, e.g., glass. The predetermined angular range of the draft angle 311 for a perfect draft may be determined to be from |θ₁| to |θ₂ (including θ₁ and θ₂). Any suitable angle between |θ₁| and |θ₂| may be used as the draft angle 311 for the perfect draft. In some embodiments, the draft angle 311 for perfect draft may be chosen as (|θ₁|+|θ₂|)/2. The draft angles 311 of the draft facets 307 located at different regions of the first lens surface 310-1 of the Fresnel lens 300 may be configured to be substantially the same, e.g., (|θ₁|+|θ₂|)/2. When the lower half of the first lens surface 310-1 is chosen to be “scanned” by the first ray 361-1 and the second ray 361-2 output from the eye-box 160, in a direction from a center portion of the first lens surface 310-1 to a peripheral portion of the first lens surface 310-1, the condition |θ₁|<|θ₂| may also be valid for determining the draft angle for the perfect draft. Note that the difference between θ₁ and θ₂ is the angle θ indicated in FIG. 3B.

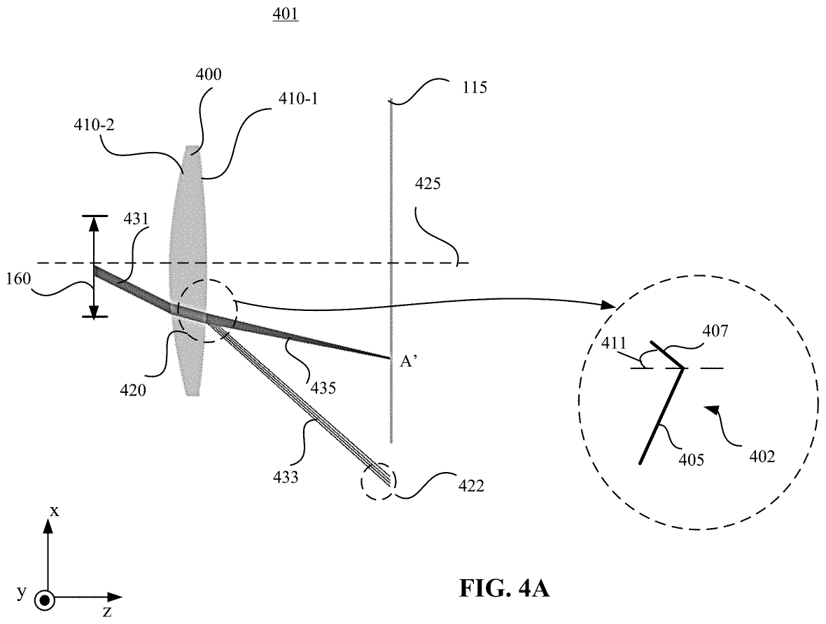

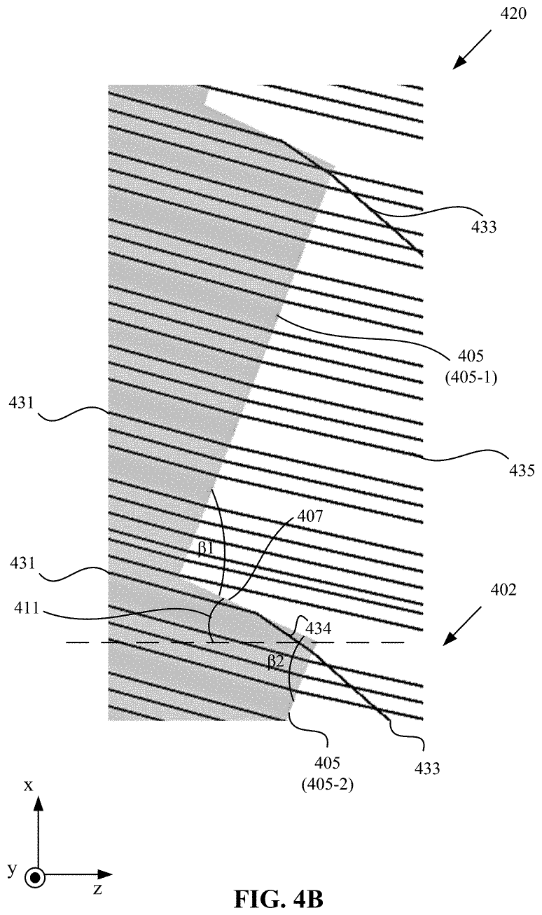

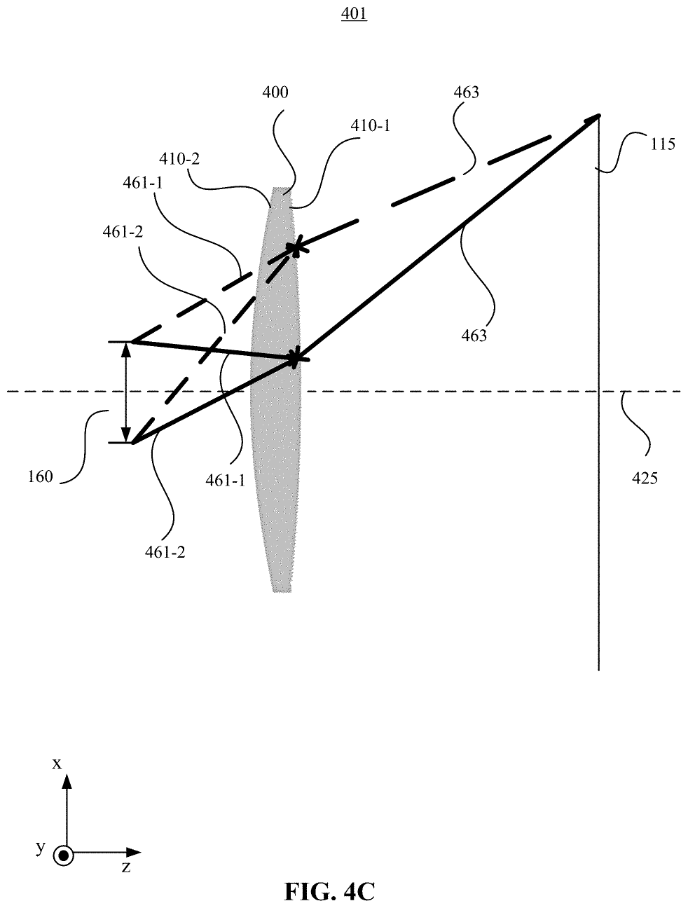

FIG. 4A illustrates an x-z sectional view of a system 401, according to an embodiment of the present disclosure. The system 401 may include a Fresnel lens 400 provided with null drafts. The term “null draft” refers to a type of draft that that generates a stray light propagating toward a region located at a side of the Fresnel lens facing the eye-box and outside of the eye-box. In some embodiments, the null draft may convert a light incident onto the Fresnel lens from a first side into a stray light propagating toward a second side of the Fresnel lens opposite to the first side. In some embodiments, all of the drafts included in the Fresnel lens 400 may be null drafts.

As shown in FIG. 4A, an image light output from the electronic display 115 may be reflected by an inner surface of the null draft as a stray light, which may propagate toward a region located at a side of the Fresnel lens facing the eye-box and outside of the eye-box. The electronic display 115 may include a display panel (also referred to as 115 for discussion purposes). The Fresnel lens 400 may have a first lens surface 410-1 facing the display panel 115 and a second lens surface 410-2 facing the eye-box 160. The Fresnel lens 400 may be configured to transform an image light, such as a divergent image light, emitted from each point on the display panel 115 to a bundle of parallel rays or a collimated light that substantially covers the eye-box 160. When the eyes of the user are placed within the eye-box 160, the user may observe an image displayed on the display panel 115.

The Fresnel lens 400 may include a plurality of Fresnel structures 402 located at, e.g., the first lens surface 410-1. FIG. 4A illustrates an enlarged view of a Fresnel structure 402 of the Fresnel lens 400, according to an embodiment of the present disclosure. As shown in FIG. 4A, the Fresnel structure 402 may include a slope facet 405 characterized by a slope angle and a draft facet 407 characterized by a draft angle 411. The draft angle 411 may be an angle formed between the draft facet 407 and a direction parallel with an optical axis 425 of the Fresnel lens 400. The draft angles 411 of the respective draft facets 407 may be specifically configured, such that when each point on the display panel 115 outputs an image light (e.g., a divergent image light) to the Fresnel lens 400, the draft facets 407 may deflect the image light incident thereon as stray lights propagating toward a region located at a side of the Fresnel lens 400 facing the eye-box 160 and located outside the eye-box 160. For example, the image light from the display panel 115 may be incident onto the inner surface of the draft facets 407 at the first lens surface 410-1, reflected by the inner surface of the draft facets 407 as stray lights output from the second lens surface 410-2 toward a region outside the eye-box 160. Thus, the eye located within the eye-box 160 may not perceive the stray lights, and may not perceive the optical artifacts caused by the stray lights.

In some embodiments, the draft angles 411 of the draft facets 407 located at different regions of the first lens surface 410-1 may be individually configured, such that each draft facet 407 may deflect the image light incident thereon toward a region outside the eye-box 160. In some embodiments, the first lens surface 410-1 may be axial symmetric with respect to the optical axis 425. For example, the first lens surface 410-1 may include a first half, e.g., an upper half shown in FIG. 4A, and a second half, e.g., a lower half shown in FIG. 4A. The upper half and the lower half may be symmetric with respect to the optical axis 425. The draft facets 407 located at the upper half and the draft facets 407 located at the lower half may be symmetric with respect to the optical axis 425. The draft angles 411 of the draft facets 407 that are symmetric with respect to the optical axis 425 may be substantially the same. In some embodiments, the draft angles 411 of the draft facets 407 that are located at different regions of the upper or lower half may be different from one another. In some embodiments, the draft angles 411 of the draft facets 407 that are located at different regions of the first lens surface 410-1 may be configured based on a distance of the respective Fresnel structure 402 from a center of the Fresnel lens 400.

FIG. 4A illustrates reversely traced rays from the eye box 160 to the display panel 115, with the Fresnel lens 400 disposed therebetween. As shown in FIG. 4A, the eye-box 160 is presumed to output a bundle of parallel rays or a collimated lights 431 toward a predetermined region 420 at the first lens surface 410-1. The predetermined region 420 may include at least one Fresnel structure 402 located at, e.g., a central portion of the Fresnel lens 400. In the embodiment shown in FIG. 4A, the collimated light 431 may be output from a center portion of the eye-box 160.

FIG. 4B illustrates an enlarged view of reversely traced rays in a portion of the predetermined region 420 of the Fresnel lens 400. As shown in FIG. 4B, a null draft (or draft facet) 407 may connect two slope facets 405 (405-1 and 405-2). The null draft 407 may form obtuse angles (31 and (32 between the slope facets 405-1 and 405-2. That is, compared with the perfect draft 307 shown in FIG. 3B, the null draft 407 is relatively “flattened” with a larger draft angle 411. A null draft may form obtuse angles with two neighboring slope facets and reflects the image light from the display panel 105 as a stray light propagating toward a region located at a side of the Fresnel lens 400 facing the eye box 160 and outside of the eye box 160.

As shown in FIG. 4A and FIG. 4B, an inner surface of a null draft 407 may intercept a ray of the light 431 incident onto the Fresnel lens 400, and may reflect the ray as a ray of a light 433, which may be a stray light, propagating to a region 422 located outside of electronic display 115.

The draft angles 411 of the draft facets 407 included in the Fresnel lens 400 may be different. In some embodiments, the draft angles 411 of all the draft facets 407 may be different. In some embodiments, at least two draft angles 411 may be different. In some embodiments, a first plurality of draft angles 411 may be the same first angle, and may be different from a second plurality of draft angles 411, which may be the same second angle. In some embodiments, the draft angles 411 may be configured, such that all stray lights generated by the null drafts 407 are directed to a same side of the Fresnel lens that is different from a light input side of the Fresnel lens. For example, for an image light emitted from the electronic display 115, the null drafts 407 may direct stray lights to an opposite side, where the eye-box 160 is located. The region to which the stray lights are directed may be outside of the eye-box 160.

Referring to FIGS. 4A and 4B, the draft angle 411 of each draft facet 407 may be configured as a null draft, such that a first portion of the collimated light 431 may be refracted by the slope facet 405 as a light 435 that is focused to a point A′ on the display panel 115, and a second portion of the light 431 may be reflected by the inner surface of the draft facet 407, e.g., via total internal reflection, as a light 434, which may be a stray light, propagating inside the Fresnel lens 400 toward the slope facet 405. The light 434 may be refracted by the slope facet 405 as the stray light 433 propagating toward the region 422 located at a side of the Fresnel lens 400 facing the display panel 115 and outside of the display panel 115. Thus, in the embodiment where the Fresnel lens 400 is formed by null drafts, the eyes located within the eye-box 160 may not perceive the stray light and the optical artifacts caused by the stray light.

In some embodiments, the draft angle 411 for a null draft may be determined through ray tracing. FIG. 4C illustrates a diagram of ray tracing for determining respective draft angles 411 for the null drafts, according to an embodiment of the present disclosure. In the ray tracing, the parameters of the system 401, e.g., the size of the Fresnel lens 400, the size of the eye-box 160, the size of the display panel of the electronic display 115, the distance between the Fresnel lens 400 and the eye-box 160, the distance between the Fresnel lens 400 and the electronic display 115, the material of the Fresnel lens 400, and the outside environment of the Fresnel lens 400, are presumed to be fixed. In the ray tracing, the pitches of the respective draft facets 407 are presumed to be infinitely small.

As the first lens surface 410-1 is axial symmetric with respect to the optical axis 425, the ray tracings between the eye-box 160 and the display panel 115 may be performed for only half of the first lens surface 410-1 to determine the respective draft angles 411 for the null drafts. For example, the upper half of the first lens surface 410-1 may be divided into a plurality of regions. Each region may include at least one Fresnel structure 402. The upper half of the first lens surface 410-1 may be “scanned” by a first ray 461-1 and a second ray 461-2 output from the eye-box 160, and a third ray 463 output from the display panel 115, in a radial direction of the first lens surface 410-1, e.g., from a center portion to a peripheral portion of the first lens surface 410-1 or from the peripheral portion to the center portion of the first lens surface 410-1.

The first ray 461-1 may be output from the upper edge of the eye-box 160 toward the respective region. The second ray 461-2 may be output from the lower edge of the eye-box 160 toward the respective region. The first ray 461-1 and the second ray 461-2 may enter the Fresnel lens 400 from the second lens surface 410-2 facing the eye-box 160. The first ray 461-1 and the second ray 461-2 may propagate from the second lens surface 410-2 to the respective region of the upper half, and exit the Fresnel lens 400 from the first lens surface 410-1 facing the display panel 115. The third ray 463 may be output from an edge of the display panel 115, e.g., the upper edge of the display panel 115 shown in FIG. 4C when scanning the upper half of the first lens surface 410-1. The third ray 463 may enter the Fresnel lens 400 from the first lens surface 410-1, propagate from the first lens surface 410-1 to the second lens surface 410-2, and exit the Fresnel lens 400 from the second lens surface 410-2.

For illustrative purposes, FIG. 4C shows that the upper half of the first lens surface 410-1 may be “scanned” by the first ray 461-1, the second ray 461-2, and the third ray 463, in a radial direction from a center portion to a peripheral portion of the first lens surface 410-1. For illustrative purposes, FIG. 4C shows that the first ray 461-1, the second ray 461-3, and the third ray 463 are incident onto a first region of the upper half at a first time moment, and incident onto a second region of the upper half, different from the first region, at a second time moment.

As scanning the upper half of the first lens surface 410-1 in the radial direction of the first lens surface 410-1, each of the first ray 461-1 and the second ray 461-2 may be incident onto the respective region of the upper half of the first lens surface 410-1 with an incidence angle in the Fresnel lens 400, e.g., glass, and refracted by the respective region of the upper half of the first lens surface 410-1 with a refraction angle in the outside environment, e.g., air. In the ray tracing, the incidence angle of a ray in the Fresnel lens 400 may be defined as an angle between the ray in the Fresnel lens 400 and the optical axis 425. The refraction angle of a ray in the outside environment, e.g., air, may be defined as an angle between the ray in the outside environment and the optical axis 425. The third ray 463 may be incident onto the respective region of the upper half of the first lens surface 410-1 with an incidence angle in the outside environment, and refracted by the respective region of the upper half of the first lens surface 310-1 with a refraction angle in the Fresnel lens 400. In the ray tracing, the incidence angle of the third ray 463 in the outside environment may be an angle between the third ray 463 in the outside environment and the optical axis 425. The refraction angle of the third ray 463 in the Fresnel lens 400 may be an angle between the third ray 463 in the Fresnel lens 400 and the optical axis 425.

As scanning the upper half of the first lens surface 410-1 in the radial direction of the first lens surface 410-1, for each region of the upper half of the first lens surface 410-1 that has been scanned or ray traced, a refraction angle θ₁ of the second ray 461-2 in the outside environment, an incidence angle θ₂ of the first ray 461-1 in the Fresnel lens 400, and a refraction angle θ₃ of the third ray 463 in the Fresnel lens 400 may be obtained via the ray tracing. In some embodiments, a draft angle 411 for a null draft may be configured to be sufficient large, such that the outer mode reflection may be suppressed, and the inner mode reflection may be deflected toward a region outside the display panel 115. In some embodiments, the draft angle 411 for a null draft may be configured to be greater than the absolute value of the refraction angle θ₁ of the second ray 461-2 in the outside environment, i.e., greater than |θ₁|, for suppressing the outer mode reflection, and greater than half of a sum of the absolute value of the incidence angle θ₂ of the first ray 461-1 in the Fresnel lens 400 and the absolute value of the refraction angle θ₃ of the third ray in the Fresnel lens 400, e.g., greater than (|θ₂|+|θ₃|)/2, for deflecting the inner mode reflection toward a region outside the display panel 115. In some embodiments, a greater of |θ₁| and (|θ₂|+|θ₃|)/2 of the respective region of the upper half of the first lens surface 410-1 may be chosen as the draft angle 411 of a draft facet located within the corresponding region.

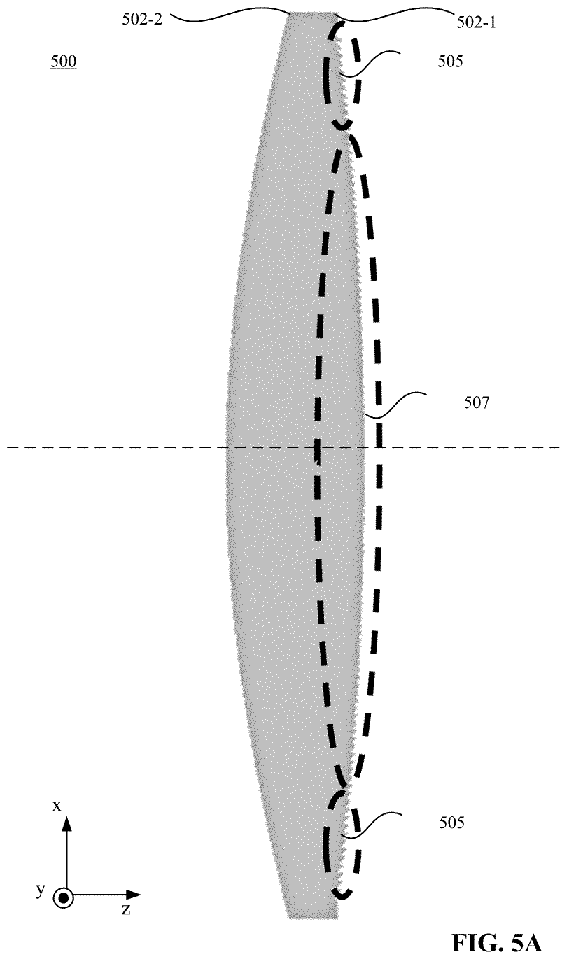

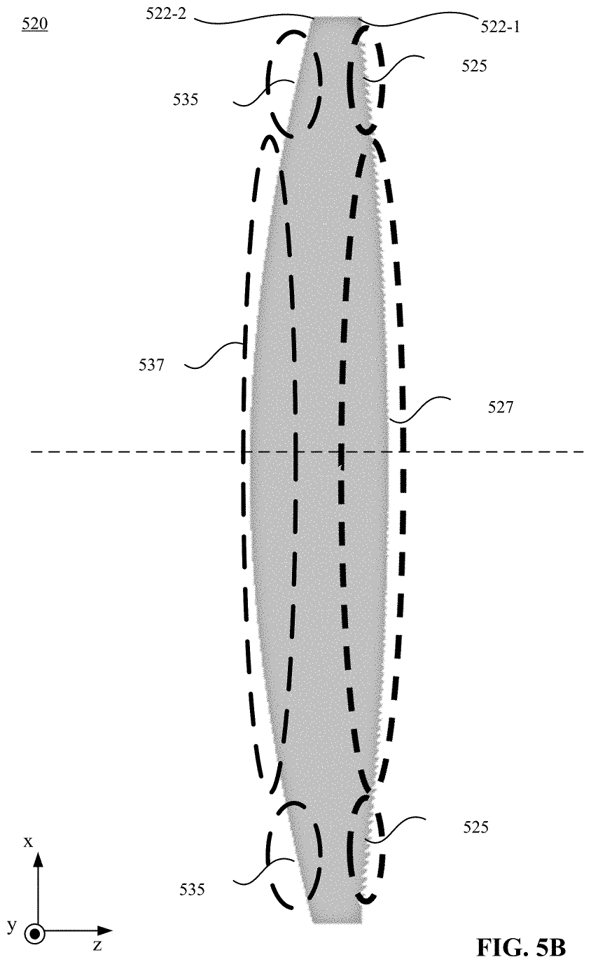

FIG. 5A illustrates an x-z sectional view of a Fresnel lens 500 including hybrid drafts, according to an embodiment of the present disclosure. The term “hybrid drafts” refer to the configuration where both perfect drafts (or a first type of drafts) and null drafts (or a second type of drafts) are included in a Fresnel lens. The Fresnel lens 500 may include elements, structures, and/or functions that are the same as or similar to those included in the Fresnel lens 300 shown in FIGS. 3A-3D and the Fresnel lens 400 shown in FIGS. 4A and 4B. Detailed descriptions of the same or similar elements, structures, and/or functions may refer to the above descriptions rendered in connection with FIGS. 3A-3D and FIGS. 4A and 4B.

As shown in FIG. 5A, the Fresnel lens 500 may have a first lens surface 502-1 and a second lens surface 502-2. At least one of the first lens surface 502-1 or the second lens surface 502-2 may include a plurality of Fresnel structures. For example, the first lens surface 502-1 of the Fresnel lens 500 may include a center portion 507 and a periphery portion 505 surrounding the center portion 507.

In some embodiments, the Fresnel structures located at the periphery portion 505 of the first lens surface 502-1 may include draft facets that are perfect drafts. In some embodiments, the draft angles of the perfect drafts may be substantially the same. In some embodiments, the draft angles of at least two perfect drafts may be differently configured based on a distance of the respective Fresnel structure 502 from a center of the first lens surface 510-1.

The Fresnel structures located at the center portion 507 may include null drafts, and may not include perfect drafts. In some embodiments, the draft angles of at least two null drafts may be differently configured based on a distance of the respective Fresnel structure from a center of the first lens surface 510-1.

In some embodiments, both of the first and second lens surfaces may include Fresnel structures. FIG. 5B illustrates an x-z sectional view of a Fresnel lens 520 with both lens surfaces include hybrid drafts, according to an embodiment of the present disclosure. The Fresnel lens 520 may include elements, structures, and/or functions that are the same as or similar to those included in the Fresnel lens 300 shown in FIGS. 3A-3D, the Fresnel lens 400 shown in FIGS. 4A and 4B, or the Fresnel lens 500 shown in FIG. 5A. Detailed descriptions of the same or similar elements, structures, and/or functions may refer to the above descriptions rendered in connection with FIGS. 3A-3D, FIGS. 4A and 4B, and FIG. 5A.

As shown in FIG. 5B, the Fresnel lens 520 may have a first lens surface 522-1 and a second lens surface 522-2. Both of the first lens surface 522-1 and the second lens surface 522-2 may include a plurality of Fresnel structures. Each of the first lens surface 522-1 and the second lens surface 522-2 may include a center portion including draft facets that are null drafts and a periphery portion including draft facets that are perfect drafts.

For example, the first lens surface 522-1 of the Fresnel lens 520 may include a center portion 527 and a peripheral portion 525 surrounding the center portion 527. In some embodiments, the Fresnel structures located at the periphery portion 525 may include draft facets that are perfect drafts. In some embodiments, the draft angles of the perfect drafts may be substantially the same. In some embodiments, the draft angles of at least two perfect drafts may be differently configured based on a distance of the respective Fresnel structure from a center of the first lens surface 522-1.

The Fresnel structures located at the center portion 527 of the first lens surface 522-1 may include null drafts and may not include perfect drafts. For example, the condition |θ₁|<|θ₂| for perfect draft may not be satisfied for the Fresnel structures located at the center portion 527 of the first lens surface 522-1. In some embodiments, the draft angles of at least two null drafts may be differently configured based on a distance of the respective Fresnel structure from a center of the first lens surface 522-1.

The second lens surface 522-2 of the Fresnel lens 520 may include a center portion 537 and a periphery portion 535. In some embodiments, the Fresnel structures located at the periphery portion 535 of the second lens surface 522-2 may include perfect drafts. In some embodiments, the draft angles of the perfect drafts may be substantially the same. In some embodiments, the draft angles of at least two perfect drafts may be differently configured based on a distance of the respective Fresnel structure from a center of the second lens surface 522-2.

The Fresnel structures located at the center portion 537 of the second lens surface 522-2 may include null drafts, and may not include perfect drafts. For example, the condition |θ₁|<|θ₂| for perfect draft may not be satisfied for the Fresnel structures located at the center portion 537 of the second lens surface 522-2. In some embodiments, the draft angles of at least two null drafts may be differently configured based on a distance of the respective Fresnel structure from a center of the second lens surface 522-2.

In some embodiments, the center portion 537 and the periphery portion 535 of the second lens surface 522-2 may be aligned with the center portion 527 and the periphery portion 525 of the first lens surface 522-1, respectively. In some embodiments, the center portion 537 and the periphery portion 535 of the second lens surface 522-2 may not be aligned with the center portion 527 and the periphery portion 525 of the first lens surface 522-1, respectively.

The disclosed Fresnel lenses shown in FIGS. 3A-5B may be Fresnel lenses with relatively low refractive index, referred to as low-refractive-index Fresnel lenses for discussion purposes. In some embodiments, the low-refractive-index Fresnel lenses may include a plurality of Fresnel structures made of a material having a refractive index less than 1.9, such as 1.85, 1.8, 1.75, 1.7, 1.65, 1.6, 1.55, 1.5, 1.45, 1.4, 1.35, 1.3, 1.25, 1.2 (which may be considered as a low refractive index). The present disclosure also provides various high-refractive-index Fresnel lenses with reduced optical artifacts. The high-refractive-index Fresnel lens may include a plurality of Fresnel structures made of a high-refractive-index material having a refractive index greater than or equal to 1.9, such as 1.9, 1.95, 2.0, 2.05, 2.1, 2.15, 2.2, 2.25, 2.3, 2.35, 2.4, 2.45, 2.5, 2.55, 2.6, 2.65, etc.

The high refractive-index material may allow the Fresnel structure to have a small slope angle to obtain refraction that is otherwise available only with a large slope angle for a Fresnel structure made with a low-refractive-index material. The small slope angle may allow the Fresnel structure to have a large width, which is measured in a radial direction of the Fresnel lens. A Fresnel lens including wide Fresnel structures may have a small point spread function (“PSF”), whereas a Fresnel lens including narrow Fresnel structures may have a large PSF, due to the diffractions caused by narrow Fresnel structures. Thus, the high-refractive-index material may reduce the diffraction caused by narrow Fresnel structures, which, in turn, increase the resolution of the image formed by the corresponding Fresnel lens. In addition, the low slope angle may allow the Fresnel structures to have a low depth, which is measured in a direction perpendicular to the plane defined by the Fresnel lens. The low depth of the Fresnel structure may reduce the visibility of the boundary of the Fresnel structures, thereby enhancing the quality of the image formed by the Fresnel lens.

In some embodiments, each Fresnel structure may have a width greater than 0.5 mm, 0.6 mm, 0.7 mm, 0.8 mm, 0.9 mm, 1.0 mm, 1.1 mm, 1.2 mm, 1.3 mm, 1.4 mm, or 1.5 mm, e.g., for a high-refractive-index Fresnel lens having a diameter between 40 and 60 mm and a focal length between 20 and 30 mm. In some embodiments, the widths of the Fresnel structures may be different. For example, the Fresnel lens may include a first Fresnel structure having a first width and a second Fresnel structure having a second width different from the first width. In some embodiments, for a high-refractive-index Fresnel lens, each Fresnel structure may have a depth less than 0.5 mm, 0.45 mm, 0.4 mm, 0.35 mm, 0.3 mm, 0.25 mm, 0.2 mm, 0.15 mm, or 0.1 mm.

In some embodiments, the high-refractive-index material may have a refractive index greater than or equal to 1.9, such as 1.9, 2.0, 2.1, 2.2, 2.3, 2.4, or 2.5, e.g., at 450 nm, 500 nm, 550 nm, 600 nm, 650 nm, 700 nm, or 750 nm. In some embodiments, the high-refractive-index material may include titanium dioxide (n=2.6), tantalum pentoxide (n=2.15), strontium titanate (n=2.4), zirconium dioxide (also called cubic zirconia, n=2.15), zinc oxide (n=2.0), zinc sulfide (n=2.37), diamond (n=2.4), or silicon carbide (n=2.64), etc. In some embodiments, the high-refractive-index material may include lanthanum having a refractive index greater than or equal to 1.9, such as 1.9, 1.95, 2.0, 2.05, 2.1, 2.15, 2.2, 2.25, 2.3, 2.35, 2.4, 2.45, 2.5, 2.55, 2.6, 2.65, etc. In some embodiments, the high refractive-index material may have a transmittance of at least 50%, 60%, 70%, 80%, or 90% over a wavelength range between 400 nm and 2000 nm. In some embodiments, the high refractive-index material may have a transmittance of a transmittance of at least 50%, 60%, 70%, 80%, or 90% over a wavelength range between 450 nm and 800 nm.

In general, a high-refractive-index material may also have a high dispersion, which is characterized by low Abbe numbers. For example, in some embodiments, the high-refractive index material may have an Abbe number less than or equal to 30, 25, 20, 19, 18, 17, or 16 (e.g., between 15 and 16). For example, titanium dioxide has an Abbe number of about 9.87, zinc oxide has an Abbe number of about 2.42, zinc sulfide has an Abbe number of about 15.43, zirconium oxide has an Abbe number of about 33.54, and silicon carbide has an Abbe number of about 25.96. In some embodiments, the high-refractive-index Fresnel lens may be optically coupled to a Pancharatnam Berry Phase (“PBP”) element, e.g., a PBP lens. The PBP element may be configured to compensate for the chromatic aberration caused by the high-refractive-index Fresnel lens. The Abbe numbers of the PBP element and the Fresnel lens may have opposite signs.

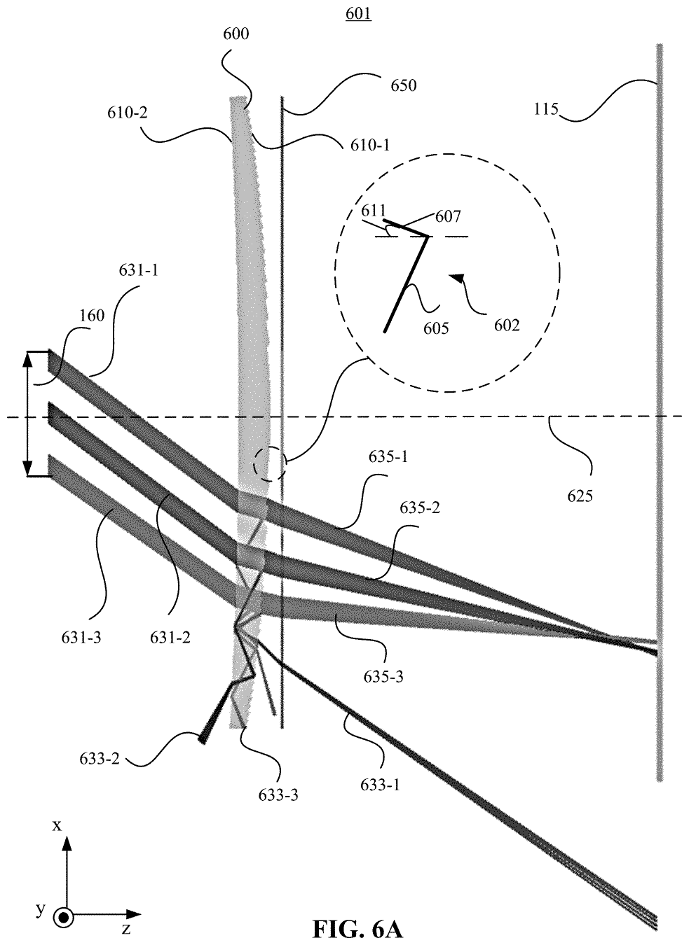

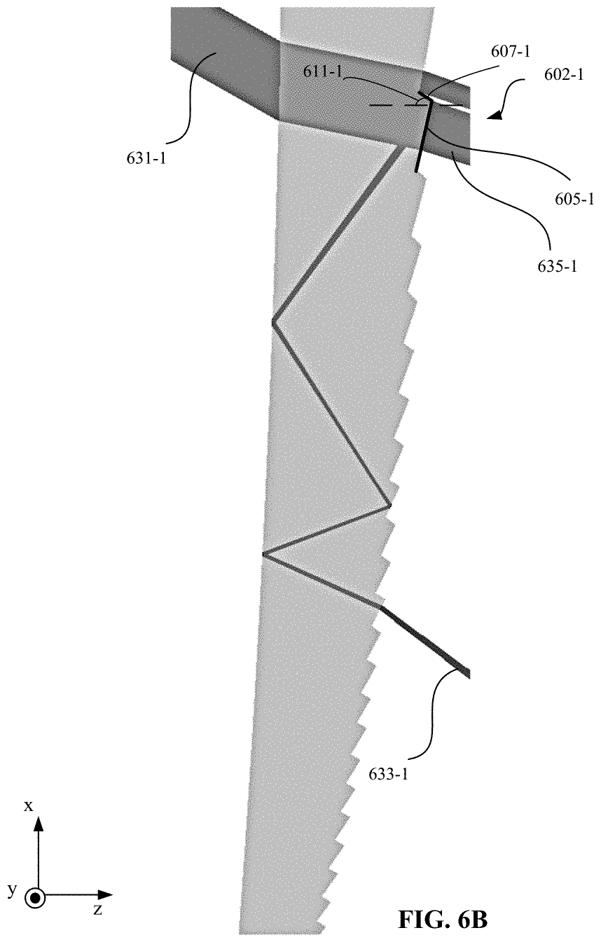

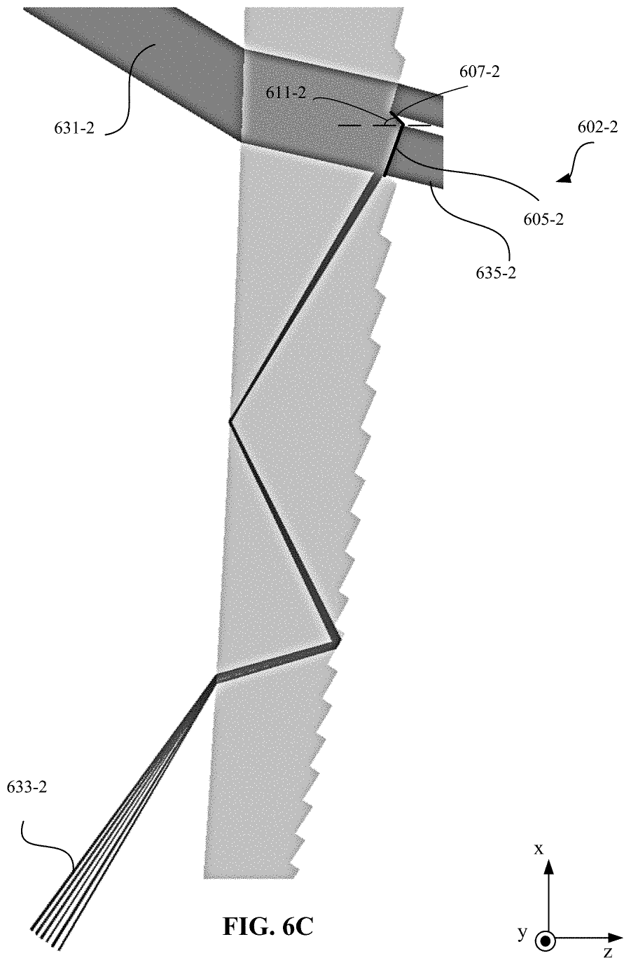

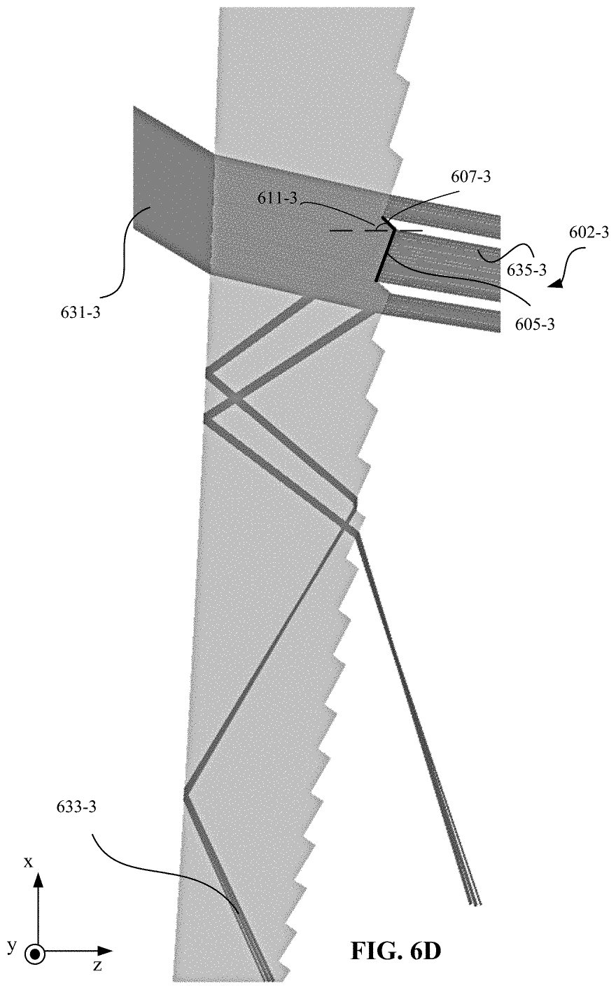

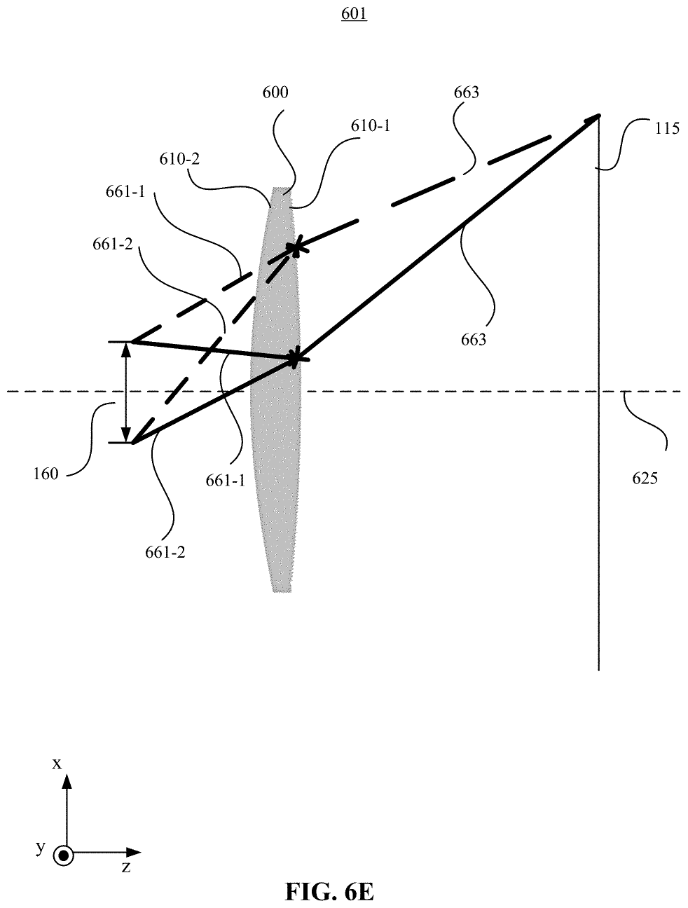

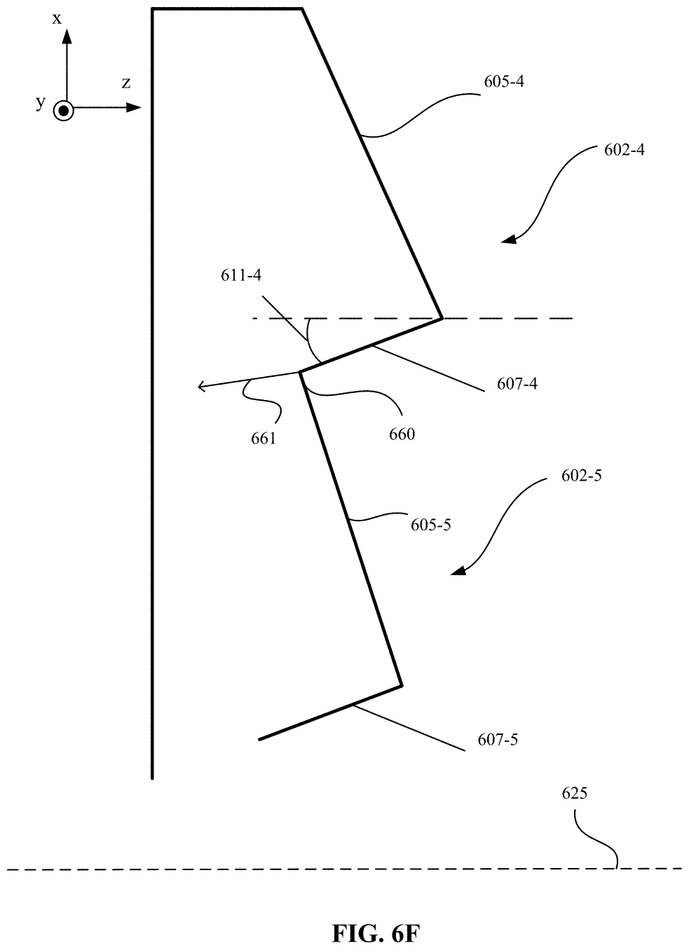

FIG. 6A illustrates an x-z sectional view of a system 601, according to an embodiment of the present disclosure. The system 601 may include the electronic display 115 and a Fresnel lens 600 configured with null-plus (“null+”) draft. The term “null-plus draft” refers to a type of draft that generates a stray light propagating toward one of the following three regions: a region located at a side of the Fresnel lens facing the eye-box and outside of the eye-box, a region located a side of the Fresnel lens facing the electronic display and outside of the electronic display, or an edge of the Fresnel lens to be absorbed by the edge of the Fresnel lens. In the Fresnel lens 600, the null-plus drafts may generate stray lights propagating toward all of the three regions mentioned above. The Fresnel lens 600 may be a high-refractive-index Fresnel lens, having a high refractive index, such as an index greater than or equal to 1.9, such as 1.9, 1.95, 2.0, 2.05, 2.1, 2.15, 2.2, 2.25, 2.3, 2.35, 2.4, 2.45, 2.5, 2.55, 2.6, 2.65, etc. The electronic display 115 may include a display panel (also referred to as 115 for discussion purposes). The Fresnel lens 600 may have a first lens surface 610-1 facing the display panel 115 and a second lens surface 610-2 facing the eye-box 160. The Fresnel lens 600 may be configured to transform an image light, such as a divergent image light, emitted from each point on the display panel 115 to a bundle of parallel rays or a collimated light that substantially covers the eye-box 160. For discussion purposes, a side of the Fresnel lens 600 at which the electronic display 115 is located may be referred to as a first side of the Fresnel lens 600, and a side of the Fresnel lens 600 at which the eye-box 160 is located may be referred to as a second side of the Fresnel lens 600.

In some embodiments, the system 601 may include a PBP element 650 configured to compensate for the chromatic aberration caused by the Fresnel lens 600. As shown in FIG. 6A, the PBP element 650 may be disposed between the Fresnel lens 600 and the display panel 115. In some embodiments, the PBP element 650 may be disposed between the Fresnel lens 600 and the eye-box 160.

In some embodiments, the null-plus drafts included in the high-refractive-index Fresnel lens 600 may be neither perfect drafts nor null drafts. FIG. 6A also illustrates an enlarged view of a Fresnel structure 602 of the Fresnel lens 600. Draft angles 611 of respective draft facets 607 (or null-plus drafts) in the Fresnel lens 600 may be specifically configured, such that when each point on the display panel of the electronic display 115 outputs an image light, such as a divergent image light, to the Fresnel lens 600, the stray lights output from the draft facets 607 may propagate toward a region located at the first side of the Fresnel lens 600 and outside of the electronic display 115. The stray lights may be absorbed by the edge of the Fresnel lens 600. For example, the stray lights may be absorbed by mounting structures disposed at the edge. Alternatively or additionally, the stray lights may propagate toward a region located at the second side of the Fresnel lens 600 and outside of the eye-box 160. Thus, the eye located within the eye-box 160 may not perceive the stray lights, and may not perceive the optical artifacts caused by the stray lights.

In some embodiments, the draft angles 611 of the draft facets 607 located at different regions of the first lens surface 610-1 may be individually configured, such that each draft facet 607 may deflect the image light incident thereon toward a region located at the first side of the Fresnel lens 600 and outside of the electronic display 115, toward a region located at the second side of the Fresnel lens 600 and outside of the eye-box 160, and/or toward the edge of the Fresnel lens 600 to be absorbed by the edge of the Fresnel lens 600.

In some embodiments, in the Fresnel lens 600, a first plurality of the null-plus drafts 607 may be configured to deflect a first portion of a divergent image light (output from the display panel 115) incident onto the Fresnel lens 600 toward a region located at a side of the Fresnel lens 600 facing the eye-box 160 and outside of the eye-box 160. A second plurality of the null-plus drafts 607 may be configured to deflect a second portion of the divergent image light toward a region located at a side of the Fresnel lens 600 facing the electronic display 115 and outside of the electronic display 115. A third plurality of the null-plus drafts 607 may be configured to deflect a third portion of the divergent image light toward an edge of the Fresnel lens 600, where the third portion of the divergent light may be absorbed by the edge of the Fresnel lens 600, such as the mounting structures at the edge. In some embodiments, the plurality of null-plug drafts 607 may be configured to perform at least two of the following: deflecting a first portion of a divergent image light (output from the display panel 115) toward a region located at a side of the Fresnel lens 600 facing the eye-box 160 and outside of the eye-box 160, deflecting a second portion of the divergent image light toward a region located at a side of the Fresnel lens 600 facing the electronic display 115 and outside of the electronic display 114, and deflecting a third portion of the divergent light toward an edge of the Fresnel lens.

In some embodiments, the first lens surface 610-1 may be axial symmetric with respect to an optical axis 625 of the Fresnel lens 600. For example, the first lens surface 610-1 may include a first half, e.g., an upper half shown in FIG. 6A, and a second half, e.g., a lower half shown in FIG. 6A. The upper half and the lower half may be symmetric with respect to the optical axis 625. The draft facets 607 located at the upper half of the first lens surface 610-1 and the draft facets 607 located at the lower half of the first lens surface 610-1 may be symmetric with respect to the optical axis 625. The draft angles 611 of the draft facets 607 that are symmetric with respect to the optical axis 625 may be substantially the same. In some embodiments, all of the draft angles 611 of the null-plus drafts may be different from one another. In some embodiments, the draft angles 611 of the draft facets 607 that are located at different regions of the upper (or lower) half of the first lens surface 610-1 may be differently configured based on a distance from the center of the Fresnel lens 600. In some embodiments, a first plurality of draft angles 611 may have a same first value, and a second plurality of draft angles 611 may have a same second value different from the first value.

FIG. 6A illustrates reversely traced rays from the eye box 160 to the display panel 115, with the Fresnel lens 600 disposed therebetween. The Fresnel lens 600 may be configured with null-plus drafts. As shown in FIG. 6A, the eye-box 160 is presumed to output three bundles of parallel rays or collimated lights 631-1, 631-2, and 631-3 toward three different regions at the first lens surface 610-1 of the Fresnel lens 600. The three different regions at the first lens surface 610-1 may include different draft facets, i.e., drafts with different draft angles. The three collimated lights 631-1, 631-2, and 631-3 may be output from an upper edge, a center, and a lower edge of the eye-box 160, respectively. In some embodiments, the draft angles of the respective draft facets (i.e., null-plus drafts) located at different regions of the first lens surface 610-1 may be individually configured. Thus, in the reversed ray tracing, the stray lights output from each draft facet may propagate toward a region located at the second side of the Fresnel lens 600 and outside of the eye-box 160, may be absorbed by the edge of the Fresnel lens 600 (e.g., by mounting structures of the Fresnel lens 600 disposed at the edge), and/or may propagate toward a region located at the first side of the Fresnel lens 600 and outside of the display panel 115.

FIG. 6B illustrates an enlarged view of a Fresnel structure 602-1 at the first lens surface 610-1 of the Fresnel lens 600. The Fresnel structure 602-1 may include a slope facet 605-1 and a draft facet 607-1. The slope facet 605-1 may refract a first portion of the light 631-1 incident thereon as a signal light 635-1 propagating toward the display panel 115. A draft angle 611-1 of the draft facet 607-1 (which is a null-plus draft) may be configured such that the draft facet 607-1 may reflect, via total internal reflection (“TIR”), a second portion of the light 631-1 incident thereon as a stray light 633-1. For example, the inner surface of the draft facet 607-1 may reflect the second portion of the light 631-1. The stray light 633-1 may propagate inside the Fresnel lens 600 via TIR, e.g., toward the periphery of the Fresnel lens 600, until the TIR condition is not satisfied. For example, the stray light 633-1 propagating inside the Fresnel lens 600 via TIR may be refracted by another slope facet toward the air, exiting the Fresnel lens 600 from the first lens surface 610-1. The stray light 633-1 output from the Fresnel lens 600 may propagate toward a region located at the first side of the Fresnel lens 600 and outside of the display panel 115.

FIG. 6C illustrates an enlarged view of a Fresnel structure 602-2 at the first lens surface 610-1 of the Fresnel lens 600. The Fresnel structure 602-2 may include a slope facet 605-2 and a draft facet 607-2. The slope facet 605-2 may refract a first portion of the light 631-2 incident thereon as a signal light 635-2 propagating toward the display panel 115. A draft angle 611-2 of the draft facet 607-2 (which is a null-plus draft) may be configured such that the draft facet 607-2 may reflect, via TIR, a second portion of the light 631-2 incident thereon as a stray light 633-2. For example, the inner surface of the draft facet 607-2 may reflect the second portion of the light 631-2. The stray light 633-2 may propagate inside the Fresnel lens 600 via TIR, e.g., toward the periphery of the Fresnel lens 600, until the TIR condition is not satisfied. For example, the stray light 633-2 propagating inside the Fresnel lens 600 via TIR may be refracted by another slope facet toward the air, exiting the Fresnel lens 600 from the second lens surface 610-2. The stray light 633-2 output from the Fresnel lens 600 may propagate toward a region located at the second side of the Fresnel lens 600 and outside of the eye-box 160. Thus, the eyes located in the eye-box 160 may not perceive the stray light 633-2 and, accordingly, may not perceive the optical artifacts caused by the stray lights 633-2 in an image formed by the Fresnel lens 600.

FIG. 6D illustrates an enlarged view of a Fresnel structure 602-3 at the first lens surface 610-1 of the Fresnel lens 600. The Fresnel structure 602-3 may include a slope facet 605-3 and a draft facet 607-3. The slope facet 605-3 may refract a first portion of the light 631-3 incident thereon as a signal light 635-3 propagating toward the display panel 115. A draft angle 611-3 of the draft facet 607-3 (which is a null-plus draft) may be configured such that the draft facet 607-3 may reflect, via TIR, a second portion of the light 631-3 incident thereon as a stray light 633-3. For example, the inner surface of the draft facet 607-3 may reflect the second portion of the light 631-3. The stray light 633-3 may propagate inside the Fresnel lens 600 via TIR, e.g., toward the periphery of the Fresnel lens 600, until being absorbed by the edge of the Fresnel lens 600 (e.g., by mounting structures of the Fresnel lens 600 disposed at the edge).

For illustrative purposes, FIGS. 6A-6D show the propagation paths of the stray lights output from three draft facets 607-1, 607-2, and 607-3 configured with null-plus drafts. The stray lights output from each of the remaining draft facets may have a propagation path similar to one of those shown in FIG. 6B, FIG. 6C, and FIG. 6D.

Referring back to FIG. 6A, the respective draft angles 611 for null-plus draft may be determined through ray tracing. In the ray tracing, the parameters of the system 601, e.g., the size of the Fresnel lens 600, the size of the eye-box 160, the size of the display panel of the electronic display 115, the distance between the Fresnel lens 600 and the eye-box 160, the distance between the Fresnel lens 600 and the electronic display 115, the material of the Fresnel lens 600, and the outside environment of the Fresnel lens 600, are presumed to be fixed.

The ray tracing for determining the draft angles 611 for respective draft facets 607 may include two stages. As the first lens surface 610-1 is axial symmetric with respect to the optical axis 625, the ray tracing may be performed for only half of the first lens surface 610-1 to determine the respective draft angles 611 for null-plus drafts. For example, the upper half of the first lens surface 610-1 may be divided into a plurality of regions. Each region may include at least one Fresnel structure 602.

FIG. 6E illustrates a diagram of a first stage ray tracing for determining draft angles for null-plus drafts, according to an embodiment of the present disclosure. In the first stage ray tracing, the pitches of the respective draft facets are presumed to be infinitely small. The first stage ray tracing may determine input ray angular ranges at the respective draft facets 607. For example, the upper half of the first lens surface 610-1 may be “scanned” by a first ray 661-1 and a second ray 661-2 output from the eye-box 160 in a radial direction of the first lens surface 610-1, e.g., from a center portion to a periphery portion of the first lens surface 610-1 or from the periphery portion to the center portion of the first lens surface 610-1.

The first ray 661-1 may be output from the upper edge of the eye-box 160 toward the respective region. The second ray 661-2 may be output from the lower edge of the eye-box 160 toward the respective region. The first ray 661-1 and the second ray 661-2 may enter the Fresnel lens 600 from the second lens surface 610-2 facing the eye-box 160, propagate from the second lens surface 610-2 to the respective region of the upper half, and exit the Fresnel lens 600 from the first lens surface 610-1 facing the display panel 115. For illustrative purposes, FIG. 6E shows that the upper half of the first lens surface 610-1 may be “scanned” by the first ray 661-1, the second ray 661-2, in a radial direction from a center portion to a periphery portion of the first lens surface 610-1. For illustrative purposes, FIG. 6E shows that the first ray 661-1 and the second ray 661-2 are incident onto a first region of the upper half at a first time moment, and incident onto a second region of the upper half, different from the first region, at a second time moment.

As scanning the upper half of the first lens surface 610-1 in the radial direction of the first lens surface 610-1, each of the first ray 661-1 and the second ray 661-2 may be incident onto the respective region of the upper half of the first lens surface 610-1 with an incidence angle in the Fresnel lens 600. In the ray tracing, the incidence angle of a ray in the Fresnel lens 600 may be defined as an angle between the ray in the Fresnel lens 600 and the optical axis 625. For each region of the upper half of the first lens surface 610-1 that has been scanned or ray traced, an incidence angle cu of the first ray 661-1 in the Fresnel lens 600, and an incidence angle α₂ of the second ray 661-3 in the Fresnel lens 600 may be obtained via the ray tracing. The input ray angular range at the respective region of the upper half of the first lens surface 610-1 may be a range between the absolute value of the incidence angle cu of the first ray 661-1 in the Fresnel lens 600 and the absolute value of the incidence angle α₂ of the second ray 661-3 in the Fresnel lens 600. The input ray angular ranges at different regions of the upper half of the first lens surface 610-1 may be different from one another. In some embodiments, the input ray angular range at the respective region of the upper half of the first lens surface 610-1 may be chosen as the input ray angular range at the draft facet located within the corresponding region.

FIG. 6F illustrates a diagram of a second stage ray tracing for determining a draft angle for a null-plus draft, according to an embodiment of the present disclosure. In the second stage ray tracing, the draft angles of the respective draft facets may be individually determined. For illustrate purposes, FIG. 6E shows two neighboring Fresnel structures 602-4 and 602-5 of the Fresnel lens 600 shown in FIG. 6A. Taking the Fresnel structure 602-4 as an example, a ray 661 may be traced from a lower tip 660 of a draft facet 607-4 of the Fresnel structure 602-4 toward the inside of the Fresnel lens 600, with a starting angle. The starting angle of the ray 661 may be an angle formed between the ray 661 and the optical axis 625 of the Fresnel lens 600.

For each possible starting angle of the ray 611, a ray tracing may be performed to obtain an output ray. If the output ray satisfies one of the three conditions, the output ray may be determined as a valid output ray: propagating toward a region located at the second side of the Fresnel lens 600 and outside of the eye-box 160, being absorbed by the edge of the Fresnel lens 600 (e.g., by mounting structures disposed at the edge), and propagating toward a region located at the first side of the Fresnel lens 600 and outside of the display panel 115. If the output ray arrives at the display panel 115, the output ray may be determined as an invalid output ray.

Based on the output rays for all the possible starting angles of the ray 611, a continuous angular space or range of the starting angle of the ray 611 at the draft facet 607-4 may be determined. The continuous angular space of the starting angle of the ray 611 at the draft facet 607-4 may be wide enough to accommodate the input ray angular range at the draft facet 607-4 that is determined in the first state ray tracing. When the starting angle of the ray 611 is within the continuous angular space, the output ray may be a valid output ray. Based on the continuous angular space of the starting angle of the ray 611 at the draft facet 607-4 and the input ray angular range at the draft facet 607-4, a draft angle 611-4 of the draft facet 607-4 may be determined according to the Fresnel's Equation for reflection. Thus, with the determined draft angle 611-4, the draft facet 607-4 may reflect, via TIR, any input rays from the eye-box 160 into the continuous angular space, thereby outputting valid rays that satisfies one of the above-mentioned three conditions. The draft angles of the remaining draft facets at the upper half of the first lens surface 610-1 may be individually determined similarly, which is not repeated.

In some embodiments, for at least one draft facet in the Fresnel lens 600, ray tracing may return two or more draft angles that satisfy the requirements for a null-plus draft. For example, for a draft facet of a certain Fresnel structure, a plurality of draft angles may be found to satisfy the requirements for a null-plus draft. In such cases, the smallest one of the plurality of draft angles may be chosen as the draft angle for the null-plus draft.

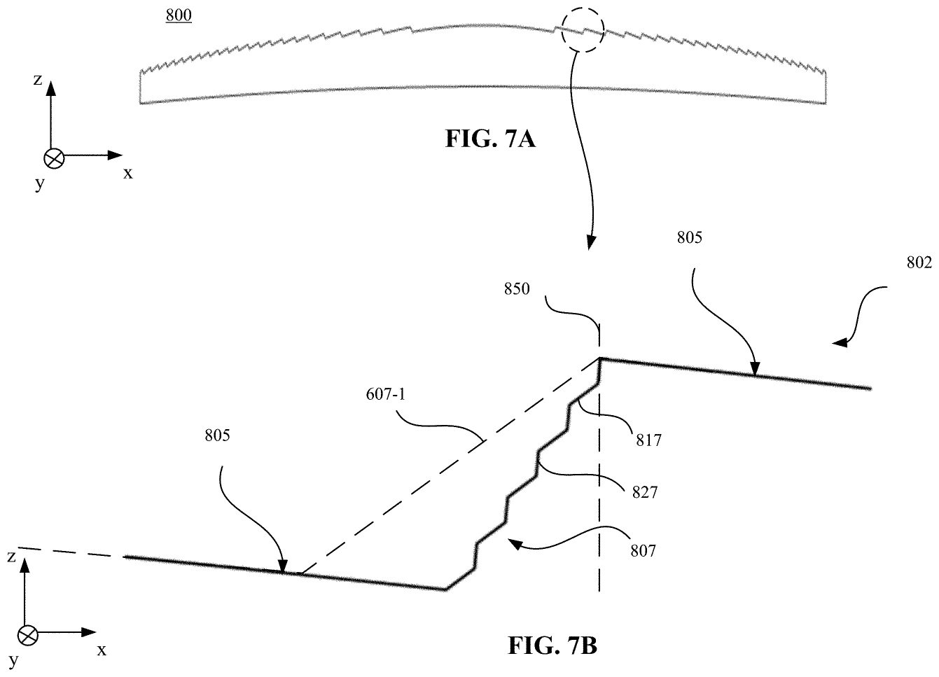

FIG. 7A illustrates an x-z sectional view of a Fresnel lens 800 with zigzag drafts, according to an embodiment of the present disclosure. FIG. 7B illustrates a schematic diagram of an enlarged view of a draft facet 807 of the Fresnel lens 800 shown in FIG. 7A, according to an embodiment of the present disclosure. The Fresnel lens 800 may be a high refractive index Fresnel lens. The Fresnel lens 800 may include elements, structures, and/or functions that are the same as or similar to those included in the Fresnel lens 300 shown in FIGS. 3A-3D, the Fresnel lens 400 shown in FIGS. 4A and 4B, the Fresnel lens 500 shown in FIG. 5A, the Fresnel lens 520 shown in FIG. 5B, or the Fresnel lens 600 shown in FIGS. 6A-6D. Detailed descriptions of the same or similar elements, structures, and/or functions may refer to the above descriptions rendered in connection with FIGS. 3A-3D, FIGS. 4A and 4B, FIG. 5A, FIG. 5B, or FIGS. 6A-6D.

As shown in FIG. 7B, the Fresnel structure 802 may include the draft facet 807 and a slope facet 805. The draft facet 807 may include, or may be divided into, a plurality of sub-draft facets, each of which is configured with a draft angle. The plurality of sub-draft facets may include at least one primary sub-draft facet 817 and at least one secondary sub-draft facet 827. In the embodiment shown in FIG. 7B, the plurality of sub-draft facets may include a plurality of primary sub-draft facets 817 and a plurality of secondary sub-draft facets 827 alternately arranged. In the respective Fresnel structure 802, the draft angles of the primary sub-draft facets 817 may be substantially the same, the draft angles of the secondary sub-draft facets 827 may be substantially the same and different from the draft angles of the primary sub-draft facets 817. That is, the draft facet 807 of the respective Fresnel structure 802 may have a non-planar surface, instead of a planar surface.

In some embodiments, in the respective Fresnel structure 802, the draft angle of the primary sub-draft facet 817 may be configured for a null-plus draft. For illustrative purposes, FIG. 7B also shows a dash line representing the draft facet 607-1, which is a null-plus draft, included in the Fresnel lens 600 shown in FIGS. 6A and 6B. The draft facet 807 with zigzag drafts may replace the draft facet 607-1 with the null-plus drafts shown in FIG. 6B. As shown in FIG. 7B, the primary sub-draft facets 817 may be substantially parallel to the draft facet 607-1, and the draft angles of the primary sub-draft facets 817 may be substantially the same as the draft angle of the draft facet 607-1. The draft angle of the secondary sub-draft facets 827 may be configured to be smaller than the draft angle of the primary sub-draft facets 817. For example, the draft angle of the secondary sub-draft facets 827 may be a few degrees and close to zero. The draft facet 807 with zigzag drafts may function similarly to the draft facet 607-1, while the visibility of the Fresnel structure 802 including the draft facet 807 with zigzag drafts may be reduced as compared to the Fresnel structure 602-1 including the draft facet 607-1 (which are null drafts). Similarly, the draft facet 607-2 in FIG. 6C and the draft facet 607-1 in FIG. 6D may also be replaced by corresponding zigzag drafts, respectively.

The Fresnel lens 800 with zigzag drafts may function similarly to the Fresnel lens 600 with the null-plus drafts, with reduced visibility of the Fresnel structure 802 as compared to the Fresnel lens 600 with the null-plus drafts. For example, when each point on the display panel of the electronic display 115 outputs an image light to the Fresnel lens 800, the stray lights output from the draft facets may propagate toward a region located at the first side of the Fresnel lens 800 and outside of the electronic display 115, may be absorbed by the edge of the Fresnel lens 800, and/or may propagate toward a region located at the second side of the Fresnel lens 800 and outside of the eye-box 160.

The design principle and mechanism of zigzag drafts may also be applicable to other Fresnel lenses, for reducing the visibility of the Fresnel structures. For example, null drafts may be replaced by corresponding draft facets with zigzag drafts.

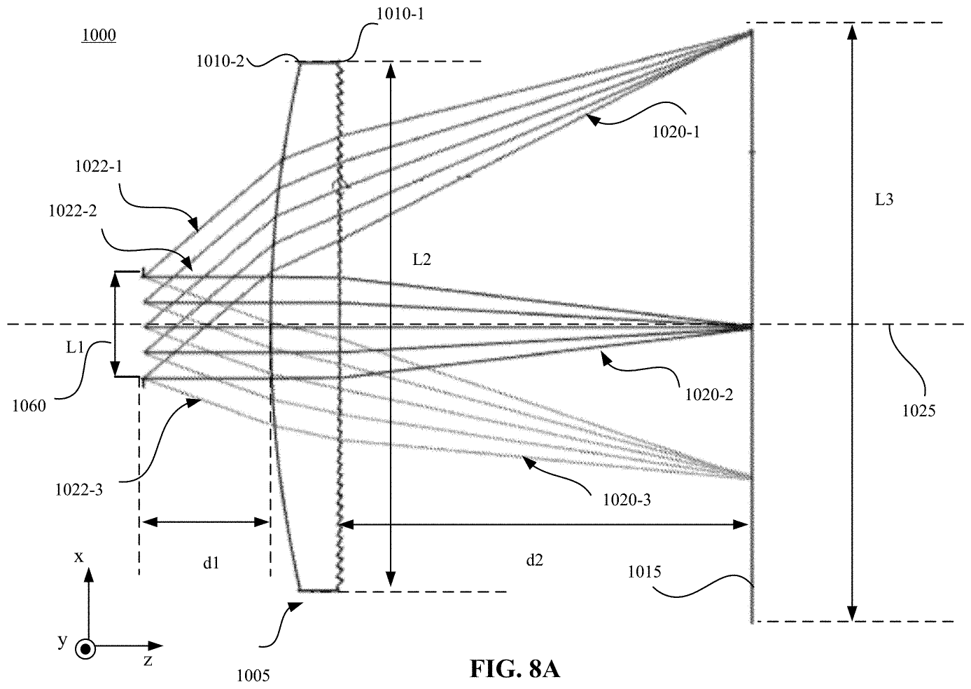

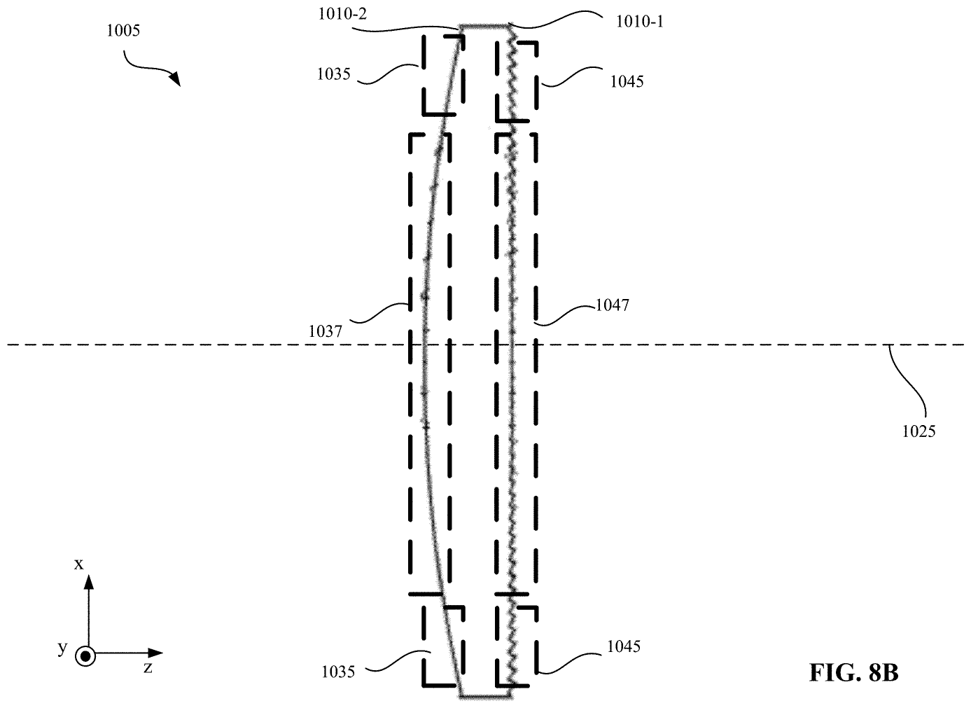

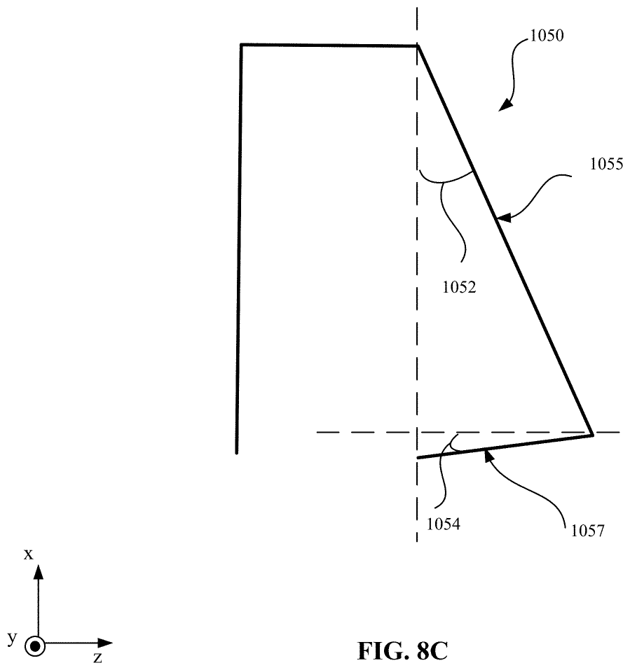

FIG. 8A illustrates an x-z sectional view of a system 1000, according to an embodiment of the present disclosure. As shown in FIG. 8A, the system 1000 may include a light outputting device 1015 configured to output a light, and a Fresnel lens 1005 configured to guide the light to a light receiving region 1060. The Fresnel lens 1005 may be disposed between the light outputting device 1015 and the light receiving region 1060. In some embodiments, the light outputting device 1015 may be an electronic display shown in other figures. In some embodiments, the light outputting device 1015 may be any suitable device, from which a light is output, such as a light source other than an electronic display, an optical element configured to deflect a light. In some embodiments, the light receiving region 1060 may be an eye-box region shown in other figures. In some embodiments, the light receiving region 1060 may be an optical sensor, or any other type of device that receives the light. The system 1000 may have an optical axis 1025 along a z-axis direction. The light outputting device 1015 may have a predetermined size L3, and may be spaced apart from the Fresnel lens 1005 by a predetermined distance d2. The light receiving region 1060 may have a predetermined size L1, and may be spaced apart from the Fresnel lens 1005 by a predetermined distance d1. The Fresnel lens 1005 may have a predetermined size, e.g., a predetermined aperture size L2.

FIG. 8B illustrates an x-z sectional view of the Fresnel lens 1005 shown in FIG. 8A, according to an embodiment of the present disclosure. The Fresnel lens 1005 may include an optically transparent substrate (also referred to as 1005 for discussion purposes) having a first lens surface 1010-1 and a second lens surface 1010-2 opposite to the first lens surface 1010-1. At least one of the first lens surface 1010-1 or the second lens surface 1010-2 may include a plurality of Fresnel structures. FIG. 8C illustrates an x-z sectional view of a Fresnel structure 1050 included in the Fresnel lens 1005 shown in FIG. 8B, according to an embodiment of the present disclosure. As shown in FIG. 8C, the respective Fresnel structure 1050 included in the Fresnel lens 1005 may include a slope facet 1055 and a draft facet 1057. The draft facet 1057 may be characterized by a draft angle 1054. The slope facet 1055 may be characterized by a slope angle 1052.

Referring to FIGS. 8B and 8C, in some embodiments, as a distance of the respective Fresnel structure 1050 from a center of the Fresnel lens 1005 increases, the slope angle 1052 of the respective slope facet 1055 may gradually increase. In some embodiments, the draft angle 1054 of the respective Fresnel structure 1050 may be specifically configured, for reducing the optical artifacts caused by the stray lights output from the draft facet 1057, reducing the visibility of the Fresnel structure 1050, and improving the quality of the image formed by the Fresnel lens 1005. The draft angle 1054 of the respective draft facet 1057 may have any suitable configuration disclosed herein. For example, the draft angle 1054 may be configured for a perfect draft, a null draft, a null-plus draft, or a zigzag draft, etc. The Fresnel lens 1005 may be an embodiment of the Fresnel lens disclosed herein, e.g., a Fresnel lens with perfect drafts, a Fresnel lens with null drafts, a Fresnel lens with hybrid drafts, a Fresnel lens with null-plus drafts, or a Fresnel lens with zigzag drafts, etc. In some embodiments, the draft angles 1054 of the draft facets 1057 that are located at different regions of the corresponding lens surface of the Fresnel lens 1005 may be different from one another. In some embodiments, the draft angles 1054 of at least two of the draft facets that are located at different regions of the corresponding lens surface of the Fresnel lens 1005 may be substantially the same.

In some embodiments, at least one of the first lens surface 1010-1 or the second lens surface 1010-2 may be a flat surface, a convex surface, a concave surface, a cylindrical surface, a freeform surface, or a combination thereof. A portion of at least one of the first lens surface 1010-1 or the second lens surface 1010-2 may include the Fresnel structures 1050. The portion may be substantially equal to the entire lens surface, or smaller than the entire lens surface. For example, in some embodiments, the Fresnel structures 1050 may be distributed across the entire lens surface. In some embodiments, the Fresnel structures 1050 may be distributed in a portion of the lens surface, rather than across the entire lens surface. A portion of the first lens surface 1010-1 or the second lens surface 1010-2 that includes the Fresnel structures 1050 may be defined by a Fresnel surface profile. A portion of the first lens surface 1010-1 or the second lens surface 1010-2 that does not include the Fresnel structures 1050 may be defined by a smooth surface profile.

In some embodiments, the first lens surface 1010-1 may include a center portion 1047, and a periphery portion 1045 surrounding the center portion 1047. The second lens surface 1010-2 may include a center portion 1037, and a periphery portion 1035 surrounding the center portion 1037. In some embodiments, the center portion 1037 and the periphery portion 1035 of the second lens surface 1010-2 may be aligned with the center portion 1047 and the periphery portion 1045 of the first lens surface 1010-2, respectively. In some embodiments, the center portion 1037 and the periphery portion 1035 of the second lens surface 522-2 may not be aligned with the center portion 1047 and the periphery portion 1045 of the first lens surface 522-1, respectively

In some embodiments, the center portion 1047 of the first lens surface 1010-1 may be configured with a Fresnel surface profile. In some embodiments, the center portion 1047 of the first lens surface 1010-1 may be configured with a smooth surface profile. In some embodiments, the periphery portion 1045 of the first lens surface 1010-1 may be configured with a Fresnel surface profile. In some embodiments, the periphery portion 1045 of the first lens surface 1010-1 may be configured with a smooth lens profile. In some embodiments, the center portion 1037 of the second lens surface 1010-2 may be configured with a Fresnel surface profile. In some embodiments, the center portion 1037 may be configured with a smooth surface profile. In some embodiments, the periphery portion 1035 of the second lens surface 1010-2 may be configured with a Fresnel surface profile. In some embodiments, the periphery portion 1035 may be configured with a smooth lens profile.

For discussion purposes, FIG. 8B shows that the first lens surface 1010-1 of the Fresnel lens 1005 may be a flat surface disposed with the Fresnel structures 1050. The second lens surface 1010-2 of the Fresnel lens 1005 may be a convex surface without Fresnel structures. Referring to FIG. 8A, for discussion purposes, FIG. 8A shows that the first lens surface 1010-1 of the Fresnel lens 1005 may face the light outputting device 1015, and the second lens surface 1010-2 of the Fresnel lens 1005 may face the light receiving region 1060.

In some embodiments, the light outputting device 1015 may emit a light toward the Fresnel lens 1005. For example, the light outputting device 1015 may include an electronic display. In some embodiments, the light outputting device 1015 may not emit a light toward the Fresnel lens 1005. Instead, the light outputting device 1015 may redirect, e.g., reflect, a light from another light source toward the Fresnel lens 1005. For example, the light outputting device 1015 may include an object, such as a real world object, which is illuminated by the light from another light source, and redirects the illumination light to the Fresnel lens 1005. In some embodiments, the Fresnel lens 1005 may transform the light output from each point on the light outputting device 1015 to a bundle of parallel rays or a collimated light that substantially covers the light receiving region 1060. In some embodiments, an eye may be placed within the light receiving region 1060. In some embodiments, an optical lens may be placed within the light receiving region 1060. In some embodiments, the optical lens may be a component of a detector, such as a camera, and may be configured to focus the light received from the Fresnel lens 1005 to a detecting area of the detector, such as a chip.

In some embodiments, the light outputting device 1015 may include the electronic display 115 configured to output an image light representing a virtual image. The electronic display 115 may include a display panel with the predetermined size L3. The light receiving region 1060 may be the eye-box 160. The Fresnel lens 1005 may transform an image light, such as a divergent image light 1020-1, 1020-2, or 1020-3, output from each point on the display panel of the electronic display 115 to a bundle of parallel rays or a collimated light that substantially covers the eye-box 160. When the eye of the user is positioned within the eye-box 160, the user may perceive the virtual image with reduced optical artifacts, reduced visibility of the Fresnel structures, and improved image quality.

FIG. 8A also shows that a central portion of the Fresnel lens 1005 may transform the image light 1020-2 output from a point located at a central portion of the display panel 115 to a bundle of parallel rays or a collimated light 1022-2 that substantially covers the eye-box 160. A peripheral portion of the Fresnel lens 1005 may transform the image light 1020-1 output from a point located at a peripheral portion of the display panel 115 to a bundle of parallel rays or a collimated light 1022-1 that substantially covers the eye-box 160. A portion of the Fresnel lens 1005 between the central portion and the peripheral portion may transform the image light 1020-3 output from a point located at a portion of the display panel 115 between the central portion and the peripheral portion to a bundle of parallel rays or a collimated light 1022-3 that substantially covers the eye-box 160.

In some embodiments, the present disclosure provides a lens. The lens may include a substrate configured to convert a divergent light incident thereon from a first side of the substrate to a collimated light substantially covering a predetermined region located at a second side of the substrate. The lens may include a plurality of Fresnel structures formed on at least one of a first lens surface or a second lens surface of the substrate. Each Fresnel structure may include a slope facet and a draft facet. At least one of the draft facets may be a first type of draft facet configured to not interact with a ray of the divergent light that is non-parallel with the at least one of the draft facets. In some embodiments, at least two of the draft facets may be the first type of draft facets. Draft angles of the at least two of the draft facets may be substantially the same. In some embodiments, both of the divergent light and the collimated light may not be incident onto the at least one of the draft facets. In some embodiments, the lens may include a material having a refractive index less than 1.9, such as 1.85, 1.8, 1.75, 1.7, 1.65, 1.6, 1.55, 1.5, 1.45, 1.4, 1.35, 1.3, 1.25, 1.2 (which may be considered as a low refractive index). In some embodiments, each draft facet of the first type may be located within a zone formed by two adjacent rays of the divergent light, one of the two adjacent rays being propagating in an external environment of the lens and the other of the two adjacent rays being propagating within the body of the lens. In some embodiments, at least one of the draft facets may be a second type of draft facet configured to reflect at least a portion of the divergent light as a light propagating toward a region located at the second side of the substrate and outside of the predetermined region. In some embodiments, the first type of draft facet may be located at a periphery portion of the substrate, and the second type of draft facet may be located at a center portion of the substrate. The second type of draft facet may be configured with a zig-zag surface.

In some embodiments, the present disclosure provides a lens. The lens may include a substrate configured to convert a divergent light incident thereon from a first side of the substrate to a collimated light substantially covering a predetermined region located at a second side of the substrate. The lens may also include a plurality of Fresnel structures formed on at least one of a first lens surface or a second lens surface of the substrate. Each Fresnel structure may include a slope facet and a draft facet. The draft facets may be configured to deflect the divergent light to a region located at the second side of the substrate and outside of the predetermined region. In some embodiments, draft angles of the draft facets may be different from one another. The lens may include a material having a refractive index less than 1.9, such as 1.85, 1.8, 1.75, 1.7, 1.65, 1.6, 1.55, 1.5, 1.45, 1.4, 1.35, 1.3, 1.25, 1.2 (which may be considered as a low refractive index). In some embodiments, the draft facets may be configured with a zig-zag surface. In some embodiments, the draft facets may be configured to reflect, at inner surfaces of the draft facets, the divergent light to the region located at the second side of the substrate and outside of the predetermined region.

In some embodiments, the present disclosure provides a lens. The lens may include a substrate configured to convert a divergent light incident thereon from a first predetermined region located at a first side of the substrate to a collimated light substantially covering a second predetermined region located a second side of the substrate. The lens may also include a plurality of Fresnel structures formed on at least one of a first lens surface or a second lens surface of the substrate. Each Fresnel structure may include a slope facet and a draft facet. The draft facets may be configured to deflect the divergent light to at least two of: a first region located at the first side of the substrate and outside of the first predetermined region, a second region located at the second side of the substrate and outside of the second predetermined region, and an edge of the substrate. The lens may include a material having a refractive index greater than or equal to 1.9, such as 1.9, 1.95, 2.0, 2.05, 2.1, 2.15, 2.2, 2.25, 2.3, 2.35, 2.4, 2.45, 2.5, 2.55, 2.6, 2.65, etc. In some embodiments, draft angles of the Fresnel structures may be different from one another. In some embodiments, a first plurality of draft facets may be configured to deflect a first portion of the divergent light to the first region located at the first side of the substrate and outside of the first predetermined region. In some embodiments, a second plurality of draft facets may be configured to deflect a second portion of the divergent light to the second region located at the second side of the substrate and outside of the second predetermined region. In some embodiments, a third plurality of draft facets may be configured to deflect a third portion of the divergent light to the edge of the substrate. At least one of the draft facets may be configured with a zig-zag surface.

In some embodiments, the present disclosure provides a system including a light outputting device configured to output a divergent light. The system may also include a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure may include a slope facet and a draft facet. At least one of the draft facets may be a first type of draft facet configured to not interact with a ray of the divergent light that is non-parallel with the at least one of the draft facets. In some embodiments, at least two of the draft facets may be the first type of draft facets, and draft angles of the at least two of the draft facets may be substantially the same. In some embodiments, both of the divergent light and the collimated light may not be incident onto the at least one of the draft facets. In some embodiments, the lens may include a material having a refractive index less than 1.9, such as 1.85, 1.8, 1.75, 1.7, 1.65, 1.6, 1.55, 1.5, 1.45, 1.4, 1.35, 1.3, 1.25, 1.2 (which may be considered as a low refractive index). In some embodiments, each draft facet of the first type may be located within a zone formed by two adjacent rays of the divergent light, one of the two adjacent rays being propagating in an external environment of the lens and the other of the two adjacent rays being propagating within a body of the lens. In some embodiments, at least one of the draft facets may be a second type of draft facet configured to reflect at least a portion of the divergent light as a light propagating toward a region located at the second side of the lens and outside of the light receiving region. In some embodiments, the first type of draft facets may be located at a periphery portion of the lens, and the second type of draft facet may be located at a center portion of the lens. In some embodiments, the second type of draft facet may be configured with a zig-zag surface.

In some embodiments, the present disclosure provides a system including a light outputting device configured to output a divergent light. The system may also include a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. Each Fresnel structure may include a slope facet and a draft facet. The draft facets may be configured to deflect the divergent light to a region located at the second side of the lens and outside of the light receiving region. In some embodiments, draft angles of the draft facets may be different from one another. In some embodiments, the lens may include a material having a refractive index less than 1.9, such as 1.85, 1.8, 1.75, 1.7, 1.65, 1.6, 1.55, 1.5, 1.45, 1.4, 1.35, 1.3, 1.25, 1.2 (which may be considered as a low refractive index). In some embodiments, the draft facet may be configured with a zig-zag surface. In some embodiments, the draft facets are configured to reflect, at inner surfaces of the draft facets, the divergent light to the region located at the second side of the lens and outside of the light receiving region.

In some embodiments, the present disclosure provides a system including a light outputting device configured to output a divergent light. The light outputting device may be an electronic display, an optical element that deflects a light, or any other suitable device from which a light may be output. The system may also include a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens. The light receiving region may be an eye-box, an optical sensor that receives the light, or any other suitable device that receives the light. Each Fresnel structure may include a slope facet and a draft facet. The draft facets may be configured to deflect the divergent light to at least two of: a first region located at the first side of the lens and outside of the light outputting device, a second region located at the second side of the lens and outside of the light receiving region, and an edge of the lens. In some embodiments, the lens may include a material having a refractive index greater than or equal to 1.9, such as 1.9, 1.95, 2.0, 2.05, 2.1, 2.15, 2.2, 2.25, 2.3, 2.35, 2.4, 2.45, 2.5, 2.55, 2.6, 2.65, etc. In some embodiments, draft angles of the Fresnel structures may be different from one another. In some embodiments, a first plurality of draft facets may be configured to deflect a first portion of the divergent light to the first region located at the first side of the lens and outside of the light outputting device. In some embodiments, a second plurality of draft facets may be configured to deflect a second portion of the divergent light to the second region located at the second side of the lens and outside of the light receiving region. In some embodiments, a third plurality of draft facets may be configured to deflect a third portion of the divergent light to the edge of the lens. In some embodiments, at least one of the draft facets is configured with a zig-zag surface.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a light outputting device configured to output a divergent light; and
a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens,
wherein each Fresnel structure includes a slope facet and a draft facet, and
wherein at least one of the draft facets is a first type of draft facet configured to not interact with a ray of the divergent light that is non-parallel with the at least one of the draft facets.

2. The system of claim 1, wherein at least two of the draft facets are the first type of draft facets, and draft angles of the at least two of the draft facets are substantially the same.

3. The system of claim 1, wherein both of the divergent light and the collimated light are not incident onto the at least one of the draft facets.

4. The system of claim 1, wherein the lens includes a material having a refractive index less than 1.9.

5. The system of claim 1, wherein each draft facet of the first type is located within a zone formed by two adjacent rays of the divergent light, one of the two adjacent rays being propagating in an external environment of the lens and the other of the two adjacent rays being propagating within a body of the lens.

6. The system of claim 1, wherein at least one of the draft facets is a second type of draft facet configured to reflect at least a portion of the divergent light as a light propagating toward a region located at the second side of the lens and outside of the light receiving region.

7. The system of claim 1, wherein the first type of draft facets is located at a periphery portion of the lens, and the second type of draft facet is located at a center portion of the lens.

8. The system of claim 1, wherein the second type of draft facet is configured with a zig-zag surface.

9. A system, comprising:
a light outputting device configured to output a divergent light; and
a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens,
wherein each Fresnel structure includes a slope facet and a draft facet, and
wherein the draft facets are configured to deflect the divergent light to a region located at the second side of the lens and outside of the light receiving region.

10. The system of claim 9, wherein draft angles of the draft facets are different from one another.

11. The system of claim 9, wherein the lens includes a material having a refractive index less than 1.9.

12. The system of claim 9, wherein the draft facet is configured with a zig-zag surface.

13. The system of claim 9, wherein the draft facets are configured to reflect, at inner surfaces of the draft facets, the divergent light to the region located at the second side of the lens and outside of the light receiving region.

14. A system, comprising:
a light outputting device configured to output a divergent light; and
a lens configured to convert the divergent light incident thereon from a first side of the lens to a collimated light substantially covering a light receiving region located at a second side of the lens, the lens including a plurality of Fresnel structures formed on at least one of a first lens surface or a second lens surface of the lens,
wherein each Fresnel structure includes a slope facet and a draft facet, and
wherein the draft facets are configured to deflect the divergent light to at least two of: a first region located at the first side of the lens and outside of the light outputting device, a second region located at the second side of the lens and outside of the light receiving region, and an edge of the lens.

15. The system of claim 14, wherein the lens includes a material having a refractive index greater than or equal to 1.9.

16. The system of claim 14, wherein draft angles of the Fresnel structures are different from one another.

17. The system of claim 14, wherein a first plurality of draft facets are configured to deflect a first portion of the divergent light to the first region located at the first side of the lens and outside of the light outputting device.

18. The system of claim 17, wherein a second plurality of draft facets are configured to deflect a second portion of the divergent light to the second region located at the second side of the lens and outside of the light receiving region.

19. The system of claim 18, wherein a third plurality of draft facets are configured to deflect a third portion of the divergent light to the edge of the lens.

20. The system of claim 14, wherein at least one of the draft facets is configured with a zig-zag surface.
